(19) United States
(12) Patent Application Publication
(10) Pub. No.: US 2023/0274757 A1
(43) Pub. Date: Aug. 31, 2023

(54) APPARATUS AND METHOD FOR INSPECTION

(71) Applicant: Hitachi, Ltd., Tokyo (JP)

(72) Inventors: Atsushi OKU, Tokyo (JP); Kazuya SUMITA, Tokyo (JP); Kozue ONISHI, Tokyo (JP); Akihiro MATSUMOTO, Tokyo (JP); Eri KUBO, Tokyo (JP); Keitaro UEHARA, Tokyo (JP)

(21) Appl. No.: 17/901,597

(22) Filed: Sep. 1, 2022

(30) Foreign Application Priority Data
Feb. 28, 2022 (JP) 2022-029065

(51) Int. Cl. G10L 25/51; G10L 25/30

(52) U.S. Cl. CPC G10L 25/51; G10L 25/30

(57) ABSTRACT

An apparatus and/or method is proposed that can show evidence for judgment results in an abnormality judgment using a judgment model obtained by machine learning. Pieces of processed data with a mask corresponding to characteristics of waveform data set on a spectrogram of waveform data are created using a judgment model obtained by machine learning by sequentially shifting the mask in a direction corresponding to the mask, a change rate or a change degree of the waveform data of each piece of created processed data from the spectrogram is calculated, each area in which the mask on the spectrogram of the waveform data is set based on the calculated change rate or change degree is colored with a color or concentration corresponding to the change rate or change degree of the processed data when the mask is set so as to draw and display a judgment evidence image.

### BACKGROUND OF THE INVENTION

### Field of the Invention

The present invention relates to an apparatus and method for inspection, which is suitable for application to abnormal sound inspection apparatus that inspects the presence or absence of abnormal sound using, for example, a machine learning model.

### Description of the Related Art

Predictions based on machine learning generally require evidence. In a case where PoC (Proof of Concept) is carried out on a model to detect whether or not abnormal sound is mixed with sound produced by a manufacturing apparatus or product at a manufacturing site, it is often the case that explanations are required as to whether or not the model prediction is based on reliable evidence.

In live operation or the like, in a case where sound data of sound emitted from a manufacturing apparatus or a product or the like collected by a microphone is inputted to a machine learning model and the quality of the manufacturing apparatus or product or the like is judged based on the presence or absence of abnormal sound, there is a need to confirm the sound that has become evidence for the quality judgment on the spot. However, it is difficult to ensure explainability of the model with respect to the sound data.

Note that as a technique for making an abnormality judgment on an inspection target using a machine learning model, Japanese Patent Application Laid-Open No. 2006-58051 discloses an acoustic inspection apparatus that processes a digitized sound signal in steps of frequency analysis, coordinate axis transformation, coordinate axis division, averaging process and strength/amplitude compression process, and then inputs the sound signal to a neural network, conducts learning using the learned data and makes an abnormality judgment on the inspection target.

On the other hand, in the image recognition field, a method for estimating features that become classification factors from a classification result by a classifier used for machine learning includes a technique called LIME (Local Interpretable Model-agnostic Explanations), SHAP (Shapley Additive exPlanations). These techniques input numerous processed (perturbation) data resulting from randomly masking part of test image data to a black box, analyze a degree of contribution of feature values from the judgment result obtained, and thereby obtain judgment evidence.

As a method for obtaining judgment evidence of an abnormal sound judgment result of sound data using a machine learning model, a publicly known technique such as LIME or SHAP may be applied to spectrogram data of time axis (x-axis)×frequency axis (y-axis) of sound data (hereinafter simply referred to as “spectrogram data”).

However, for sound such as impulse sound, features of which appear in a direction parallel to the frequency axis (hereinafter referred to as “frequency direction”) or sound such as consecutive sound, features of which appear in a direction parallel to the time axis (hereinafter referred to as “time direction”), the method randomly applying masking to an area has a problem that characteristics of sound data are lost, and so it may be difficult to extract evidence.

Regarding sound data of sound collected at a site, it is often the case that there are fewer silence elements and there is some sound such as environment sound on the frequency axis and the time axis as a whole. In this case, if 0 (silence) is applied as a masking value of the area as the case with the publicly known technique, the difference of sound data before and after the use of masking increases, and so even if the sound is normal, the anomaly score of masked sound is calculated to be high, resulting in a problem that the explainability of judgment evidence deteriorates.

The present invention has been implemented with the above-mentioned points taken into account, and it is an object of the present invention to propose a highly value-added inspection apparatus and method that can reliably show evidence for judgment results in an abnormality judgment using a judgment model obtained by machine learning.

### SUMMARY OF THE INVENTION

In order to solve the above-mentioned problems, the present invention is an inspection apparatus that judges the presence or absence of abnormality based on a spectrogram of waveform data, the inspection apparatus being provided with an inspection judgment section that calculates anomaly score of the spectrogram of the waveform data using a judgment model obtained by machine learning and judges the presence or absence of abnormality based on the calculated anomaly score, a processed data creation section that creates a plurality of pieces of processed data with a mask corresponding to characteristics of the waveform data set on the spectrogram of the waveform data so as to sequentially shift the mask in a direction corresponding to the mask, an anomaly score/change degree calculation section that calculates anomaly score of the processed data created by the processed data creation section and calculates each change rate or change degree of the waveform data of the processed data from the spectrogram based on the anomaly score of each piece of calculated processed data and the anomaly score of the spectrogram of the waveform data calculated by the inspection judgment section, a judgment evidence drawing section that draws a judgment evidence image obtained by coloring each area in which the mask on the spectrogram of the waveform data is set based on the change rate or change degree of the calculated processed data from the spectrogram of the waveform data, with a color or concentration corresponding to the change rate or change degree of the processed data when the mask is set, and a result display section that displays the judgment result of the inspection judgment section and the judgment evidence image drawn by the judgment evidence drawing section.

The present invention provides an inspection method for judging the presence or absence of abnormality based on a spectrogram of waveform data, the method including a first step of calculating anomaly score of the spectrogram of the waveform data using a judgment model obtained by machine learning and judging the presence or absence of abnormality based on the calculated anomaly score, a second step of creating a plurality of pieces of processed data with a mask corresponding to characteristics of the waveform data set on the spectrogram of the waveform data so as to sequentially shift the mask in a direction corresponding to the mask, a third step of calculating anomaly score of the created processed data and calculating each change rate or change degree of the waveform data of the processed data from the spectrogram based on the calculated anomaly score of each piece of processed data and the calculated anomaly score of the spectrogram of the waveform data, a fourth step of drawing a judgment evidence image obtained by coloring each area in which the mask on the spectrogram of the waveform data is set based on the change rate or change degree of the calculated processed data from the spectrogram of the waveform data, with a color or concentration corresponding to the change rate or change degree of the processed data when the mask is set, and a fifth step of displaying the judgment result about the presence or absence of the abnormality and the drawn judgment evidence image.

According to the inspection apparatus and method of the present invention, it is possible to reliably show evidence for the judgment result of abnormality judgment using a judgment model obtained by machine learning.

### Advantageous Effect of the Invention

According to the present invention, it is possible to implement a highly value-added inspection apparatus and method.

### BRIEF DESCRIPTION OF THE DRAWINGS

FIG. 1 is a block diagram illustrating an overall configuration of an abnormal sound inspection apparatus according to first and second embodiments;

FIG. 2A is a diagram illustrating an example of a spectrogram of impulse sound and FIG. 2B is a diagram provided to describe a time direction mask;

FIG. 3A is a diagram illustrating an example of a spectrogram of steady sound and FIG. 3B is a diagram provided to describe a frequency direction mask;

FIG. 4 is a table provided to describe anomaly score and a change degree;

FIG. 5 is a diagram illustrating a configuration example of a judgment evidence image;

FIG. 6A is a diagram illustrating an example of the spectrogram when both impulse sound and steady sound are included and FIG. 6B is a diagram provided to describe a time direction mask and a frequency direction mask in that case;

FIG. 7A is a diagram illustrating an example of the spectrogram when the inspection target sound contains environment sound and FIG. 7B is a diagram provided to describe a mask value in that case;

FIG. 8 is a block diagram illustrating a logical configuration of the abnormal sound inspection apparatus according to the first and second embodiments;

FIG. 9 is a table provided to describe various settings for the abnormal sound inspection apparatus of the first embodiment;

FIG. 10 is a flowchart illustrating a processing procedure of abnormal sound inspection processing;

FIG. 11 is a flowchart illustrating a processing procedure of mask creation processing;

FIG. 12 is a flowchart illustrating a processing procedure of time direction mask creation processing;

FIG. 13 is a flowchart illustrating a processing procedure of frequency direction mask creation processing;

FIG. 14 is a flowchart illustrating a processing creation processing according to the first embodiment;

FIG. 15 is a flowchart illustrating a processing procedure of processed data creation processing;

FIG. 16 is a flowchart illustrating a processing procedure of time direction processed data creation processing;

FIG. 17 is a flowchart illustrating a processing procedure of frequency direction processed data creation processing;

FIG. 18 is a flowchart illustrating a processing procedure of time direction×frequency direction processed data creation processing;

FIG. 19 is a flowchart illustrating a processing procedure of first anomaly score/change rate calculation processing;

FIG. 20 is a flowchart illustrating a processing procedure of second anomaly score/change rate calculation processing;

FIG. 21 is a flowchart illustrating a processing procedure of judgment evidence drawing;

FIGS. 22A and 22B are diagrams provided for an outline explanation of the second embodiment;

FIG. 23 is a table provided to describe various settings for the abnormal sound inspection apparatus of the second embodiment;

FIG. 24 is a flowchart illustrating a processing creation processing according to the second embodiment; and

FIG. 25 is a table provided to describe another embodiment.

### DETAILED DESCRIPTION OF THE PREFERRED EMBODIMENTS

Hereinafter, an embodiment of the present invention will be described in detail with reference to the accompanying drawings.

### (1) First Embodiment

### (1-1) Configuration of Abnormal Sound Inspection Apparatus According to Present Embodiment

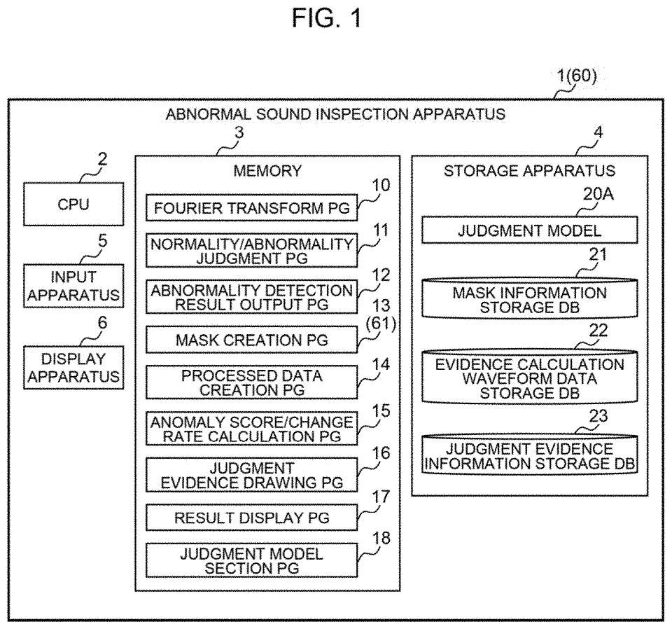

In FIG. 1, reference numeral 1 denotes an abnormal sound inspection apparatus according to the present embodiment as a whole. The abnormal sound inspection apparatus 1 is a computer apparatus equipped with a function of judging normality/abnormality of sound to be inspected (hereinafter referred to as “inspection target sound”) based on the presence or absence of abnormal sound, and is configured to include a CPU (central processing unit) 2, a memory 3, a storage apparatus 4, an input apparatus 5 and a display apparatus 6.

The CPU 2 is a processor that controls the operation of the entire abnormal sound inspection apparatus 1. The memory 3 is constructed of, for example, a volatile semiconductor memory and is used as a work memory of the CPU 2. The memory 3 stores and retains various programs such as a Fourier transform program 10, a normality/abnormality judgment program 11, an abnormality detection result output program 12, a mask creation program 13, a processed data creation program 14, an anomaly score/change rate calculation program 15, a judgment evidence drawing program 16, a result display program 17 and a judgment model section program 18, read from the storage apparatus 4 when the abnormal sound inspection apparatus 1 starts up or when needed.

The storage apparatus 4 is constructed of a large-volume non-volatile storage apparatus such as a hard disk apparatus or an SSD (solid state drive) and stores and retains various programs and data or the like requiring long-term saving. The storage apparatus 4 stores and retains a judgment model 20A, a mask information storage database 21, an evidence calculation waveform data storage database 22 and a judgment evidence information storage database 23, which will be described later.

The input apparatus 5 is constructed of, for example, a mouse and a keyboard and is used for the user to input necessary information or instruction. On the other hand, the display apparatus 6 is constructed of a liquid crystal display or an organic EL (electro-luminescence) display or the like and is used to display various screens. Note that as the input apparatus 5 and the display apparatus 6, a touch panel in which the input apparatus and the display apparatus are integrated may also be applied.

### (1-2) Abnormal Sound Inspection Function According to Present Embodiment

### (1-2-1) Display of Judgment Evidence Based on Abnormal Sound Inspection Function According to the Present Embodiment

Next, an abnormal sound inspection function installed in the abnormal sound inspection apparatus 1 will be described. The abnormal sound inspection function is a function that displays judgment results of normality/abnormality of an inspection target sound, judged based on the presence or absence of abnormal sound and evidence of the judgment results together.

Before describing the abnormal sound inspection function, characteristics of a spectrogram obtained by short-time Fourier transforming impact sound that instantaneously appears in inspection target sound as abnormal sound (hereinafter referred to as “impulse sound”) and sound data of constant frequency sound that continues such as motor sound (hereinafter referred to as “steady sound”) will be described first.

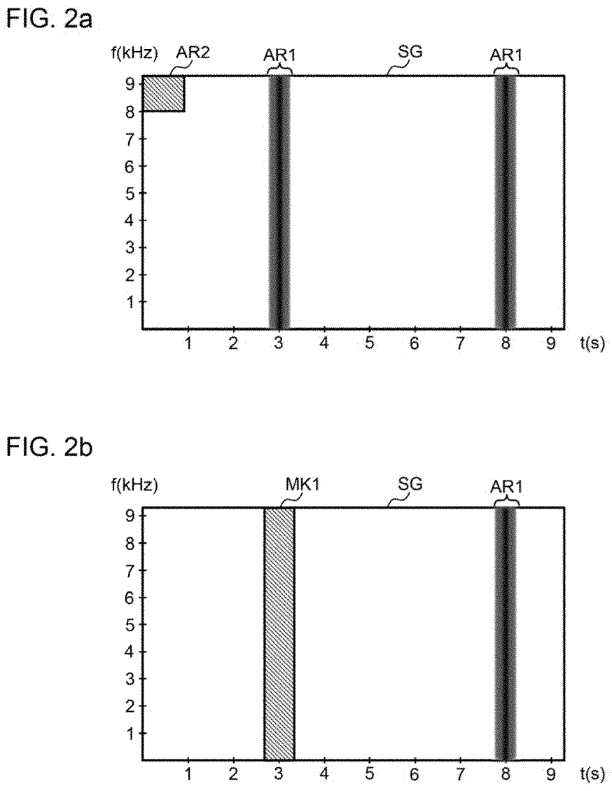

FIG. 2A illustrates an example of a spectrogram SG obtained by short-time Fourier transforming impulse sound. As shown in FIG. 2A, such a spectrogram SG has a feature that a dark-colored elongated area AR1 over an entire range in the frequency direction parallel to the frequency direction. In contrast to such a spectrogram SG, a case will be considered where the features are extracted by applying an existing image recognition techniques such as LIME and SHAP as is. Note that in FIG. 2A, the dark-colored area indicates that there is a strong sound pressure and the light-colored area indicates that there is a weak sound pressure.

An area AR2 in FIG. 2A indicates an area masked by LIME, SHAP or the like. Although the shape of a mask is random according to LIME or SHAP, an example in which the mask is assumed to be rectangular is shown here. FIG. 2A illustrates a state in which a mask for explanation is set at the top left of the spectrogram SG, whereas when the existing image recognition technique such as LIME or SHAP is applied, the mask is set at an arbitrary location of the spectrogram SG. LIME or SHAP or the like sequentially creates data of a plurality of mask-processed spectrograms SG while randomly switching mask positions so that all parts of the spectrogram SG are masked at least once.

When anomaly score of the spectrogram SG is calculated for data of each spectrogram SG created in this way for each mask position using a known technique such as GMM (Gaussian mixture model) and features are extracted in the spectrogram SG based on the calculation result, since only part of the area AR1 with such features is masked, features of the sound may be lost, which may prevent judgment evidence from being estimated.

For example, in the case of FIG. 2A, although the target sound has a sound range of 9 kHz or more, if the top end part of the area AR1 is covered with the mask, the target sound is treated as sound having only a sound range of approximately 8 kHz. Therefore, the anomaly score obtained by being applied to the model shows a large alienation between inspection sound (here 0 to 9 kHZ) and masked sound (here 0 to 8 kHZ) (AI regards it as different sound). As a result, it may be impossible to accurately calculate the anomaly score or change rate/change degree of the anomaly score and it may be impossible to estimate evidence using these numerical values (and perform drawing of the judgment evidence as will be described later).

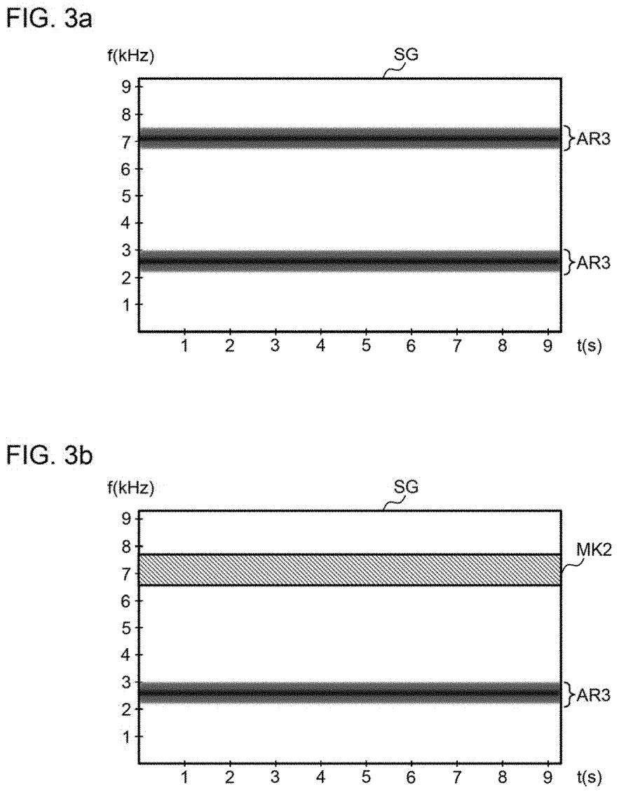

On the other hand, FIG. 3A illustrates an example of a spectrogram SG obtained by short-time Fourier transforming sound data of steady sound. As shown in FIG. 3A, such a spectrogram SG has a feature that a dark-colored elongated area AR3 appears over the entire time direction range parallel to the time direction. In contrast to such a spectrogram SG, even if the existing image recognition technique such as LIME or SHAP is applied as is, sound features may be lost as the case with FIG. 2A, making it impossible to estimate judgment evidence.

Therefore, according to the present embodiment, the above-mentioned problems are solved by setting a mask corresponding to characteristics of sound included in the inspection target sound for the spectrogram SG of sound data of inspection target sound detected by an advance inspection (hereinafter referred to as “inspection target sound data” as appropriate).

To be more specific, in the case of the present embodiment, data of the inspection target sound is subjected to short-time Fourier transform, and when features appear only in the frequency direction on the obtained spectrogram SG as shown in FIG. 2A, an elongated rectangular mask MK1 over an entire range of the frequency direction parallel to the frequency direction as shown in FIG. 2B (hereinafter referred to as “time direction mask”) is set on the spectrogram SG. As the width (mask width) in the time direction of the time direction mask MK1 at this time, one with the maximum number of samples arranged in the time direction (samples number) in an area where a sound pressure of the inspection target sound in such a spectrogram SG is equal to or larger than a threshold set in advance (hereinafter referred to as “feature sound pressure threshold”) is selected and applied.

Note that in a case where a sampling frequency of the inspection target sound is, for example, 16000 (1/s) and a time period of the inspection target sound is 9 seconds, “the number of samples” here refers to the number of samples constituting one dark-colored area AR1, which is continuous in the time direction of all samples in the time direction calculated by the following equation:

[Expression 1]

16000×9 (1)

the values of which are continuous in the time direction equal to or larger than a feature sound pressure threshold. According to the present embodiment, when it is confirmed, by an advance inspection, that features appear only in the time direction on the spectrogram SG of the inspection target sound data as shown in FIG. 2A (that is, the inspection target sound contains only impulse sound), only the time direction mask MK1 is used, as will be described later, but a maximum value of the number of samples is applied as a mask width of the time direction mask MK1.

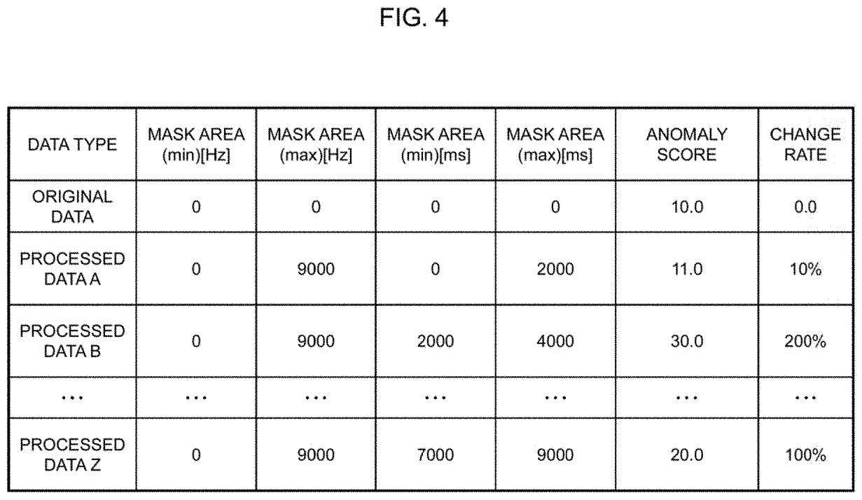

In order for all the areas in the spectrogram SG to be masked at least one time, this time direction mask MK1 is sequentially shifted in the time direction at intervals of the mask width of the time direction mask MK1 and the spectrogram SG data in which the time direction mask MK1 is set at different positions is sequentially created as processed data. Furthermore, as shown in FIG. 4, anomaly score of the created processed data is calculated using a known technique such as GMM and the change rate from the spectrogram SG data before setting the time direction mask MK1 for the processed data (spectrogram SG data of inspection target sound data, and hereinafter referred to “original data”) is calculated by the following equation:

$$\begin{matrix}[ Expression 2 ] & \\ CHANGE RATE = \frac{ANOMOLY SCORE OF PROCESSED DATA}{ANOMOLY SCORE OF ORIGINAL DATA} \times 100 - 100 & ( 2 )\end{matrix}$$

Similarly, the inspection target sound data is subjected to short-time Fourier transform, and when features appear only in the frequency direction in the acquired spectrogram SG as shown in FIG. 3A, an elongated rectangular mask (hereinafter referred to as “frequency direction mask”) MK2 over the entire range in the time direction parallel to the time direction is set on the spectrogram SG as shown in FIG. 3B. As the width (mask width) in the frequency direction of the frequency direction mask MK2 at this time, one with a maximum number of elements arranged in the frequency direction in the area where the sound pressure of the inspection target sound is equal to or larger than the above-mentioned feature sound pressure threshold is selected and applied.

Note that “the number of elements” here refers to the number of elements (frequencies) that constitute one dark-colored area AR3 continuous in the frequency direction, and the values of which are continuous in the frequency direction equal to or larger than the feature sound pressure threshold. According to the present embodiment, when it is confirmed, by an advance inspection, that features appear only in the frequency direction on the spectrogram SG of the inspection target sound data as shown in FIG. 3A (that is, the inspection target sound contains only steady sound), only the frequency direction mask MK2 is used, as will be described later, but the maximum value of the number of elements is applied as the mask width of the frequency direction mask MK2.

In order for all the areas on the spectrogram SG to be masked at least one time, this frequency direction mask MK2 is sequentially shifted in the frequency direction at intervals of the mask width of the frequency direction mask MK2 and the spectrogram SG data in which the frequency direction mask MK2 is set at different positions is sequentially created as processed data. Furthermore, anomaly score and a change rate of the created processed data is calculated in the same way as above.

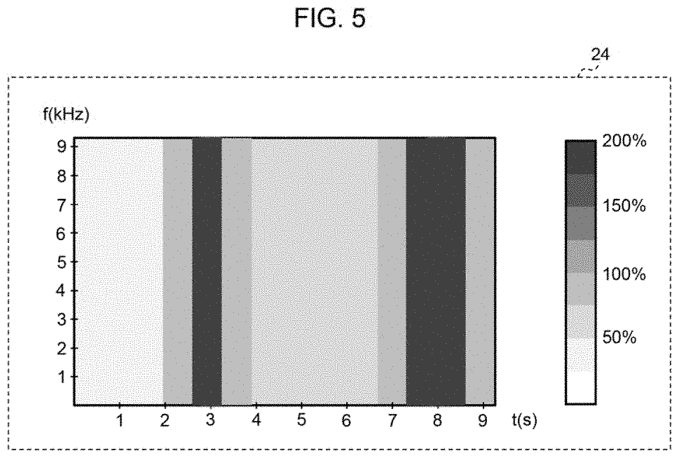

After this, for example, as shown in FIG. 5, a judgment evidence image 24 is generated by plotting (coloring) each position at which the time direction mask MK1 and the frequency direction mask MK2 are set on the spectrogram SG of the inspection target sound data with a color or concentration corresponding to the change rate when the time direction mask MK1 and the frequency direction mask MK2 are set at the respective positions. Note that FIG. 5 is an example when features appear only in the time direction in the spectrogram SG of the inspection target sound. In this way, when abnormality of the inspection target sound is detected, it is possible to visually present to the user, which location on the spectrogram SG of the inspection target sound has become evidence of abnormality detection.

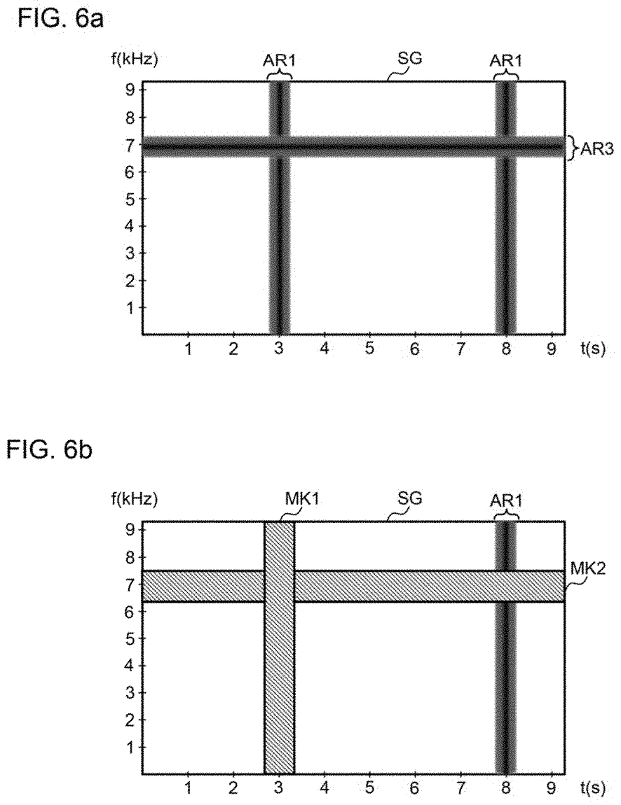

Note that when, for example, the inspection target sound contains both impulse sound and steady sound, and features appear in both the time direction and the frequency direction on the spectrogram SG as shown in FIG. 6A, both the time direction mask MK1 and the frequency direction mask MK2 are used as shown in FIG. 6B. Accordingly, even in the case where the inspection target sound contains both the impulse sound and the steady sound, it is possible to visually present to the user, which location on the spectrogram SG of the inspection target sound has become evidence in the abnormality detection. Accordingly, it is possible to make it hard to lose sound characteristics compared to cases with LIME or SHAP where randomly selected areas are masked.

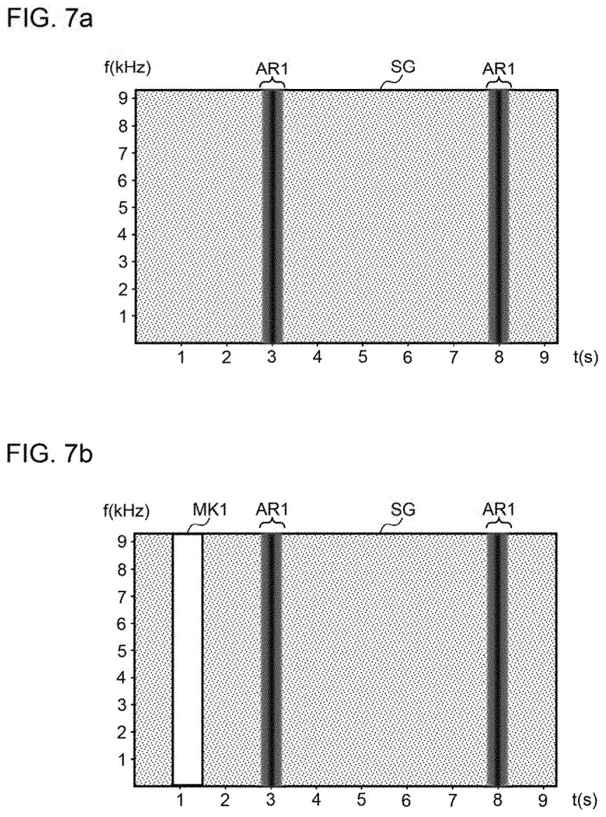

On the other hand, for example, as shown in FIG. 7A, when overall environment sound or noise is mixed with the inspection target sound, if the above-mentioned method is applied assuming that the data values in the time direction mask MK1 or the frequency direction mask MK2 to be set on the spectrogram SG as shown in FIG. 7B (hereinafter referred to as “mask values”) are “0” used in LIME or SHAP or the like, the difference in nature between the original data (spectrogram SG data of inspection target sound data) and the processed data in which the time direction mask MK1 or the frequency direction mask MK2 is set increases and a large error may occur in anomaly score of calculated processed data.

Therefore, in the present embodiment, sound data in which only environment sound is recorded in advance and a spectrogram SG obtained by short-time Fourier transforming the sound data is used to determine mask values for mask setting positions of the time direction mask MK1 and the frequency direction mask MK2 to be set at predetermined positions corresponding to the mask widths on the spectrogram SG of the inspection target sound data (hereinafter referred to as “mask setting positions”).

More specifically, for each mask setting position, when an average value of environment sound in the area corresponding to the mask setting position on the spectrogram SG of the environment sound data is equal to or larger than a threshold set in advance (hereinafter referred to as “mask sound pressure threshold”), the average value is applied as a mask value of the time direction mask MK1 or the frequency direction mask MK2 at the mask setting position. When the average value of the sound pressure of the environment sound in that area is smaller than the mask sound pressure threshold, a value set in advance by the user (e.g., mask sound pressure threshold) is applied as the mask value of the time direction mask MK1 or the frequency direction mask MK2 at the mask setting position.

In this way, when the sound pressure of the environment sound contained in the inspection target sound is large, by setting the average value of the sound pressure as the mask value, it is possible to reduce the difference in nature between the original data and processed data and prevent occurrences of large errors in anomaly score to be calculated.

On the other hand, when an auto encoder method machine learning model is applied as the machine learning model, anomaly score is calculated for each pixel of the spectrogram of the inspection target sound data.

Therefore, according to the present embodiment, when the machine learning model is an auto encoder method machine learning model, an average value of abnormality values of the respective pixels in the area where neither the time direction mask MK1 nor the frequency direction mask MK2 of the spectrogram of the inspection target sound data is set (hereinafter referred to as “non-processed area”) is calculated as an abnormality value of the spectrogram of the inspection target sound data when the time direction mask MK1 or the frequency direction mask MK2 is set at the corresponding mask setting position. Accordingly, it is possible to cut influences of the masked parts, and thereby calculate more accurate anomaly score.

### (1-2-2) Logical Configuration of Abnormal Sound Inspection Apparatus According to Present Embodiment

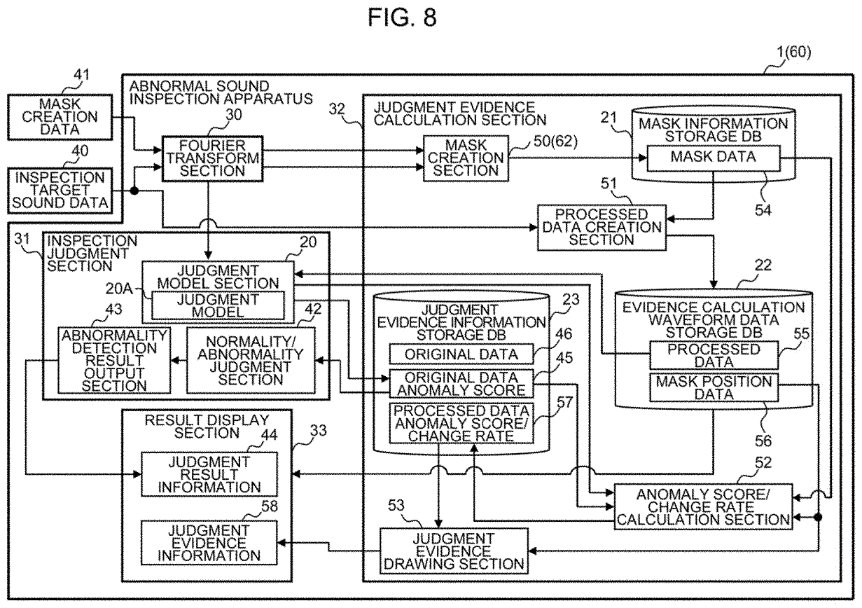

FIG. 8 illustrates a logical configuration of the abnormal sound inspection apparatus 1 according to the above-mentioned present embodiment in FIG. 1. As shown in FIG. 8, the abnormal sound inspection apparatus 1 is configured to include a Fourier transform section 30, an inspection judgment section 31, a judgment evidence calculation section 32 and a result display section 33.

The Fourier transform section 30 is a functional section embodied when the CPU 2 (FIG. 1) of the abnormal sound inspection apparatus 1 executes the Fourier transform program 10 read into the memory 3. The Fourier transform section 30 short-time Fourier transforms the inspection target sound data 40, which is sound data of inspection target sound recorded in advance and outputs the spectrogram SG data obtained to the judgment model 20A provided for a judgment model section 20 of the inspection judgment section 31, which will be described later, and a mask creation section 50 of the judgment evidence calculation section 32. The Fourier transform section 30 short-time Fourier transforms mask creation data 41 made up of sound data of only the environment sound recorded in advance and outputs the spectrogram SG data obtained to the mask creation section 50 of the judgment evidence calculation section 32.

The inspection judgment section 31 is a functional section including a function of judging normality/abnormality of the inspection target sound and is configured to include the judgment model section 20, a normality/abnormality judgment section 42 and an abnormality detection result output section 43.

The judgment model section 20 is a functional section embodied when the CPU 2 (FIG. 1) of the abnormal sound inspection apparatus 1 executes the judgment model section program 18 (FIG. 1) read into the memory 3 (FIG. 1) and is provided with the judgment model 20A. The judgment model 20A is a machine learning model created by machine learning the anomaly score of the inspection target sound utilizing a known technique such as GMM using leaning inspection target sound data provided in advance as learning data.

During live operation, the judgment model section 20 is given spectrogram SG data of inspection target sound data from the Fourier transform section 30. The judgment model section 20 inputs the inspection target sound data to the judgment model 20A. The judgment model 20A calculates anomaly score of the inputted inspection target sound data using GMM or the like. The judgment model section 20 stores the anomaly score calculated at this time in the judgment evidence information storage database 23 of the judgment evidence calculation section 32, which will be described later, as original data anomaly score 45. The judgment model section 20 also stores the spectrogram SG data of the inspection target sound data 40 given to the judgment model section 20 at that time in the judgment evidence information storage database 23 as original data 46.

The normality/abnormality judgment section 42 is a functional section embodied when the CPU 2 (FIG. 1) of the abnormal sound inspection apparatus 1 executes the normality/abnormality judgment program 11 (FIG. 1) read into the memory 3 (FIG. 1). The normality/abnormality judgment section 42 judges normality/abnormality of the original data 46 (by extension, inspection target sound) based on the original data anomaly score 45 stored in the judgment evidence information storage database 23 as described above. For example, when the original data anomaly score 45 is smaller than a threshold set in advance, the normality/abnormality judgment section 42 judges that the original data 46 is normal, whereas when the original data anomaly score 45 is equal to or larger than the threshold, it judges that the original data 46 is abnormal. The normality/abnormality judgment section 42 notifies the abnormality detection result output section 43 of such a judgment result.

The abnormality detection result output section 43 is a functional section embodied when the CPU 2 of the abnormal sound inspection apparatus 1 executes the abnormality detection result output program 12 (FIG. 1) read into the memory 3. The abnormality detection result output section 43 outputs the judgment result of normality/abnormality of the original data 46 notified from the normality/abnormality judgment section 42 to the result display section 33 as the judgment result information 44.

On the other hand, the judgment evidence calculation section 32 is a functional section having a function of calculating evidence of the judgment result of the judgment model 20A provided for the judgment model section 20 of the inspection judgment section 31, and is configured to include the mask creation section 50, a processed data creation section 51, an anomaly score/change rate calculation section 52, a judgment evidence drawing section 53, the mask information storage database 21, the evidence calculation waveform data storage database 22 and the judgment evidence information storage database 23.

The mask creation section 50 is a functional section embodied when the CPU 2 of the abnormal sound inspection apparatus 1 executes the mask creation program 13 (FIG. 1) read into the memory 3. The mask creation section 50 has a function of calculating mask widths of the time direction mask MK1 and the frequency direction mask MK2 to be set on the spectrogram SG of the inspection target sound data 40 and mask values at the respective mask setting positions of the time direction mask MK1 and the frequency direction mask MK2 on the spectrogram SG of the inspection target sound data 40.

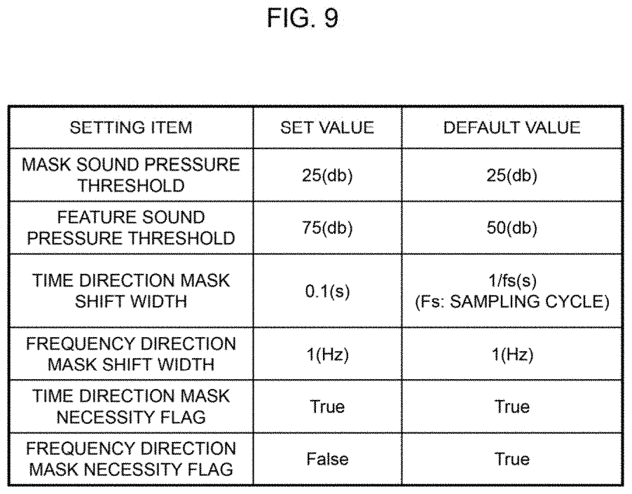

Actually, as shown in FIG. 9, the abnormal sound inspection apparatus 1 is provided with the above-mentioned mask sound pressure threshold to determine mask widths of the time direction mask MK1 and the frequency direction mask MK2 described above in FIG. 2B and FIG. 3B, the above-mentioned feature sound pressure threshold to extract feature regions from the spectrogram SG of the inspection target sound data 40, a mask sound pressure threshold, a feature sound pressure threshold, a time direction mask shift width and a frequency direction mask shift width specified by the user in advance with respect to their default values regarding the time direction mask shift width and the frequency direction mask shift width, which will be described later.

The abnormal sound inspection apparatus 1 manages a mask necessity flag indicating whether or not the time direction mask MK1 should be used (hereinafter referred to as “time direction mask necessity flag”) and a mask necessity flag indicating whether or not the frequency direction mask MK2 should be used (hereinafter referred to as “frequency direction mask necessity flag”). When the user makes a setting that the time direction mask MK1 should be used (that is, when the user makes a setting that the presence or absence of impulse sound should be judged), the value of the time direction mask necessity flag is set to “True” and when the user makes a setting that the frequency direction mask MK2 should be used (that is, when the user makes a setting that the presence or absence of steady sound should be judged), the value of the frequency direction mask necessity flag is set to “True.” Furthermore, when the user makes a setting as shown in FIG. 6B that both the time direction mask MK1 and the frequency direction mask MK2 should be used, both the time direction mask necessity flag and the frequency direction mask necessity flag are set to “True.”

The mask creation section 50 calculates each mask width of the time direction mask MK1 and/or the frequency direction mask MK2 to be created at that time, and a mask value at each mask setting position of the time direction mask MK1 and/or the frequency direction mask MK2 based on the spectrogram SG data of the inspection target sound data 40 given from the Fourier transform section 30, the spectrogram SG data of the mask creation data 41 and above-mentioned various settings by the user in FIG. 9. The mask creation section 50 stores the calculated mask widths and mask values for the respective mask setting positions as mask data 54 in the mask information storage database 21.

The processed data creation section 51 is a functional section embodied when the CPU 2 of the abnormal sound inspection apparatus 1 executes the processed data creation program 14 (FIG. 1) read into the memory 3. The processed data creation section 51 creates processed data 55 by sequentially shifting the time direction mask MK1 and/or the frequency direction mask MK2 set on the spectrogram SG of the inspection target sound data 40 by the mask width in the time direction and in the frequency direction using the spectrogram SG data of the inspection target sound data 40 and the mask data 54 stored in the mask information storage database 21. The processed data creation section 51 stores the created and processed data 55 and mask position data 56 indicating a position on the spectrogram SG in which the time direction mask MK1 and/or the frequency direction mask MK2 is set at that time (mask setting position) in the evidence calculation waveform data storage database 22.

After this, the processed data 55 stored in the evidence calculation waveform data storage database 22 is sequentially read by the anomaly score/change rate calculation section 52 from the evidence calculation waveform data storage database 22 and sequentially supplied to the judgment model section 20 of the inspection judgment section 31. The judgment model section 20 sequentially inputs the supplied processed data 55 to the judgment model 20A. The judgment model section 20 sequentially outputs anomaly scores of the processed data 55 calculated by the judgment model 20A to the anomaly score/change rate calculation section 52.

The anomaly score/change rate calculation section 52 is a functional section embodied when the CPU 2 of the abnormal sound inspection apparatus 1 executes the anomaly score/change rate calculation program 15 (FIG. 1) read into the memory 3. The anomaly score/change rate calculation section 52 calculates a change rate of the processed data 55 based on the original data anomaly score 45 stored in the judgment evidence information storage database 23 and anomaly scores of the processed data 55 given from the judgment model section 20 of the inspection judgment section 31 according to Equation (2) above. The anomaly score/change rate calculation section 52 stores the anomaly score and change rate of the processed data 55 as processed data anomaly score/change rate information 57 in the judgment evidence information storage database 23.

The processed data anomaly score/change rate information 57 for the processed data 55 is read by the judgment evidence drawing section 53 from the judgment evidence information storage database 23.

The judgment evidence drawing section 53 is a functional section embodied when the CPU 2 of the abnormal sound inspection apparatus 1 executes the judgment evidence drawing program 16 (FIG. 1) read into the memory 3. The judgment evidence drawing section 53 reads the mask position data 56 of the processed data 55 from the evidence calculation waveform data storage database 22, draws the above-mentioned judgment evidence image 24 in FIG. 5 based on the mask position data 56 of the read processed data 55 and the processed data anomaly score/change rate information 57 of the processed data 55 read from the judgment evidence information storage database 23 and outputs the image data of the drawn judgment evidence image 24 as judgment evidence information 58 to the result display section 33.

The result display section 33 is a functional section embodied when the CPU 2 of the abnormal sound inspection apparatus 1 executes the result display program 17 (FIG. 1) read into the memory 3. The result display section 33 displays the normality/abnormality judgment result of the inspection target sound (e.g., “the anomaly score of the inspection target sound is 100 with respect to abnormality judgment threshold 10”) based on the judgment result information 44 given from the abnormality detection result output section 43 of the inspection judgment section 31 and the above-mentioned judgment evidence image 24 in FIG. 5 based on the judgment evidence information 58 given from the judgment evidence drawing section 53 of the judgment evidence calculation section 32 on the display apparatus 6 (FIG. 1).

### (1-2-3) Various Processes Related to Abnormal Sound Inspection Function of Present Embodiment

Next, specific processing contents of a series of processes executed by the abnormal sound inspection apparatus 1 in association with the abnormal sound inspection function according to the above-mentioned present embodiment (hereinafter referred to as “abnormal sound inspection processing”) will be described. Note that although the processing entity of each process will be described hereinafter as a functional section (“ . . . section”), it goes without saying that in actuality, the CPU 2 of the abnormal sound inspection apparatus 1 executes the processing based on a program corresponding to the functional section.

### (1-2-3-1) Abnormal Sound Inspection Processing

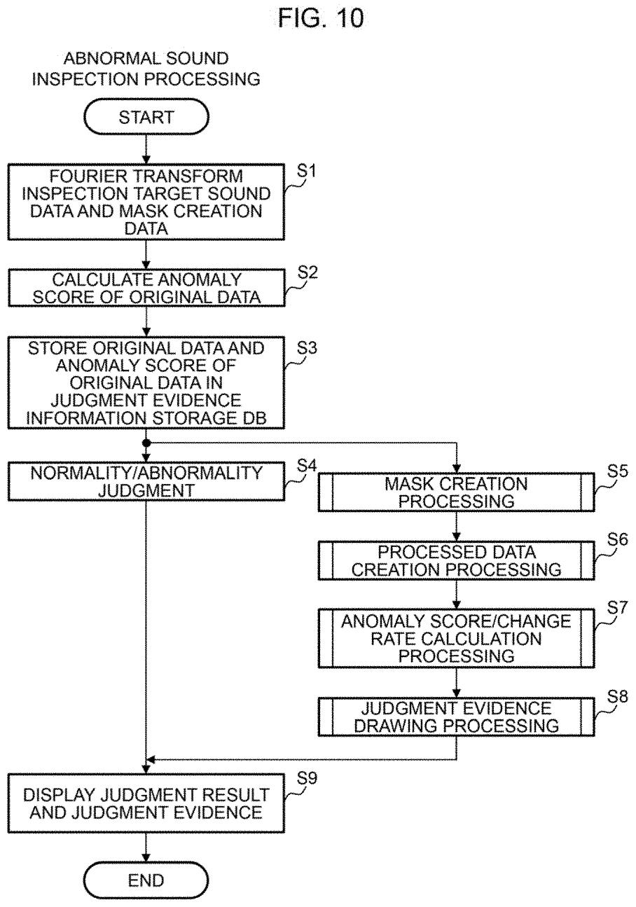

FIG. 10 illustrates a specific processing flow of such abnormal sound inspection processing. The abnormal sound inspection processing starts at predetermined timing. Such “predetermined timing” may be timing at which abnormality is detected, regular timing (e.g., fixed time every day) or arbitrary timing corresponding to user operation.

When such abnormal sound inspection processing is started, the Fourier transform section 30 short-time Fourier transforms the inspection target sound data 40 first, and outputs the acquired spectrogram SG data to the judgment model section 20 of the inspection judgment section 31 and the mask creation section 50 of the judgment evidence calculation section 32. The Fourier transform section 30 also short-time Fourier transforms the mask creation data 41 and outputs the acquired spectrogram SG to the mask creation section 50 (S1).

Next, the judgment model section 20 inputs the spectrogram SG data of the inspection target sound data 40 given from the Fourier transform section 30 to the judgment model 20A to thereby calculate anomaly score of the spectrogram SG (S2). The judgment model section 20 stores the anomaly score calculated from the judgment model 20A as the original data anomaly score 45 in the judgment evidence information storage database 23 of the judgment evidence calculation section 32 and also stores the spectrogram SG data of the inspection target sound data 40 as the original data 46 in the judgment evidence information storage database 23 (S3).

Next, the normality/abnormality judgment section 42 of the inspection judgment section 31 judges whether or not the original data 46 (by extension, inspection target sound) is normal, based on the original data anomaly score 45 stored in the judgment evidence information storage database 23 and outputs the judgment result as the judgment result information 44 to the result display section 33 via the abnormality detection result output section 43 (S4).

On the other hand, after the end of step S3, along with the process in step S4, the mask creation section 50 of the judgment evidence calculation section 32 calculates user-specified mask widths of the time direction mask MK1 and/or the frequency direction mask MK2 and a mask value at each mask setting position of the time direction mask MK1 and/or frequency direction mask MK2 based on the spectrogram SG data of the inspection target sound data 40 given from the Fourier transform section 30, the spectrogram SG data of the mask creation data 41 and the initial setting by the user. The mask creation section 50 stores the calculated mask width and the mask value at each mask setting position as the mask data 54 in the mask information storage database 21 (S5). Hereinafter, a series of processes is called “mask creation processing.”

Next, the processed data creation section 51 sequentially shifts the time direction mask MK1 and/or the frequency direction mask MK2 on the spectrogram SG of the inspection target sound data 40 by the mask width in the time direction or the frequency direction based on the mask data 54 stored in the mask information storage database 21 and sequentially creates processed data 55 consisting of spectrogram SG data in which the time direction mask MK1 and the frequency direction mask MK2 are set at different mask setting positions. The processed data creation section 51 stores the created processed data 55 in the evidence calculation waveform data storage database 22 and stores the mask setting positions at which the time direction mask MK1 and the frequency direction mask MK2 for the processed data 55 are set, as the mask position data 56 in the evidence calculation waveform data storage database 22 (S6). Hereinafter, the series of processes is called “processed data creation processing.”

The processed data 55 stored in the evidence calculation waveform data storage database 22 is sequentially read from the evidence calculation waveform data storage database 22 by the anomaly score/change rate calculation section 52, supplied to the judgment model section 20 of the inspection judgment section 31 and sequentially inputted to the judgment model 20A. As a result, anomaly scores of the processed data 55 are sequentially calculated by the judgment model 20A and the calculated anomaly scores of the processed data 55 are sequentially given from the judgment model section 20 to the anomaly score/change rate calculation section 52.

Based on the anomaly scores of the processed data 55 and the original data anomaly score 45 stored in the judgment evidence information storage database 23, the anomaly score/change rate calculation section 52 calculates change rates of the processed data 55 from the original data 46 (spectrogram SG data of the inspection target sound data 40) and stores the calculated anomaly scores and change rates of the processed data 55 as the processed data anomaly score/change rate information 57 in the judgment evidence information storage database 23 (S7). Hereinafter, the series of processes will be called “anomaly score/change rate calculation processes.”

After this, the judgment evidence drawing section 53 creates above-mentioned judgment evidence image 24 in FIG. 5 based on the processed data anomaly score/change rate information 57 for the processed data 55 stored in the judgment evidence information storage database 23 and outputs the created image data of the judgment evidence image 24 as the judgment evidence information 58 to the result display section 33 (S8). Hereinafter, the series of processes will be called “judgment evidence drawing.”

Thus, the result display section 33 displays the judgment result of normality/abnormality with respect to the inspection target sound based on the judgment result information 44 given from the inspection judgment section 31 and the judgment evidence image 24 based on the judgment evidence information 58 given from the judgment evidence drawing section 53 of the judgment evidence calculation section 32 on the display apparatus 6 (S9). This completes the abnormal sound inspection processing.

### (1-2-3-2) Mask Creation Processing

### (1-2-3-2-1) Specific Processing Contents of Mask Creation Processing

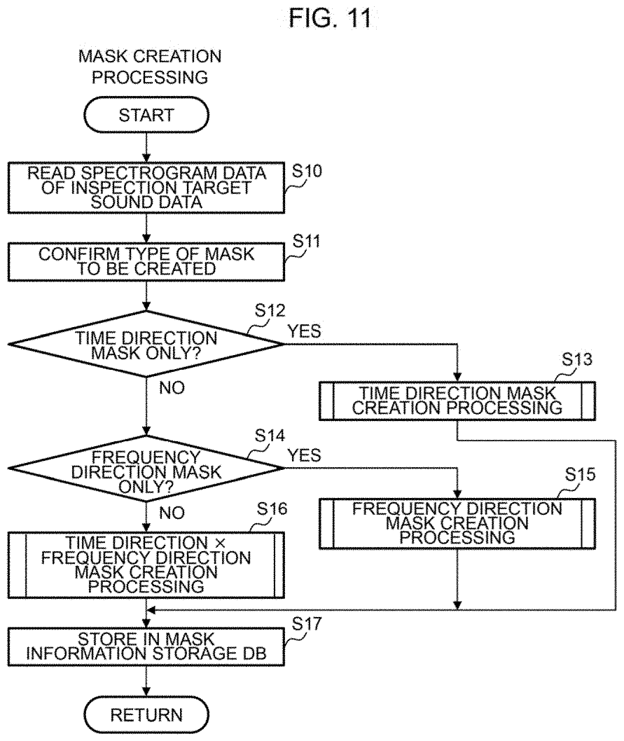

FIG. 11 illustrates a specific flow of mask creation processing executed by the mask creation section 50 in step S5 of the above-mentioned abnormal sound inspection processing in FIG. 10. When the abnormal sound inspection processing proceeds to step S5, the mask creation section 50 starts the mask creation processing and reads the spectrogram SG data of the inspection target sound data 40 given from the Fourier transform section 30 first (S10).

Next, the mask creation section 50 confirms the type (the time direction mask MK1 and/or the frequency direction mask MK2) of the mask to be created at that time set in advance by the user (S11) and judges whether or not the mask to be created at that time is only the time direction mask MK1 (S12). If this judgment yields a positive result, the mask creation section 50 executes time direction mask creation processing to calculate a mask width of the time direction mask MK1 to be created and a mask value at each mask setting position of the time direction mask MK1 (S13) and then proceeds to step S17.

When a negative result is obtained in step S12, the mask creation section 50 judges whether or not the mask to be created at that time is only the frequency direction mask MK2 (S14). If this judgment yields a positive result, the mask creation section 50 executes frequency direction mask creation processing to calculate a mask width of the frequency direction mask MK2 to be created and a mask value at each mask setting position of the frequency direction mask MK2 (S15) and then proceeds to step S17.

In contrast, getting a negative result in the judgment in step S14 means that the masks to be created include both the time direction mask MK1 and the frequency direction mask MK2. Thus, for both the time direction mask MK1 and the frequency direction mask MK2 to be created at this time, the mask creation section 50 executes time direction×frequency direction mask creation processing to calculate a mask width and a mask value at each mask setting position of the time direction mask MK1 and the frequency direction mask MK2 (S16), and then proceeds to step S17.

Upon proceeding to step S17, the mask creation section 50 stores mask widths of the time direction mask MK1 and/or frequency direction mask MK2 calculated in step S13, step S15 or step S16 and mask values at the respective mask setting positions as the mask data 54 in the mask information storage database 21 (S17), and then ends the mask creation processing.

### (1-2-3-2-2) Time Direction Mask Creation Processing

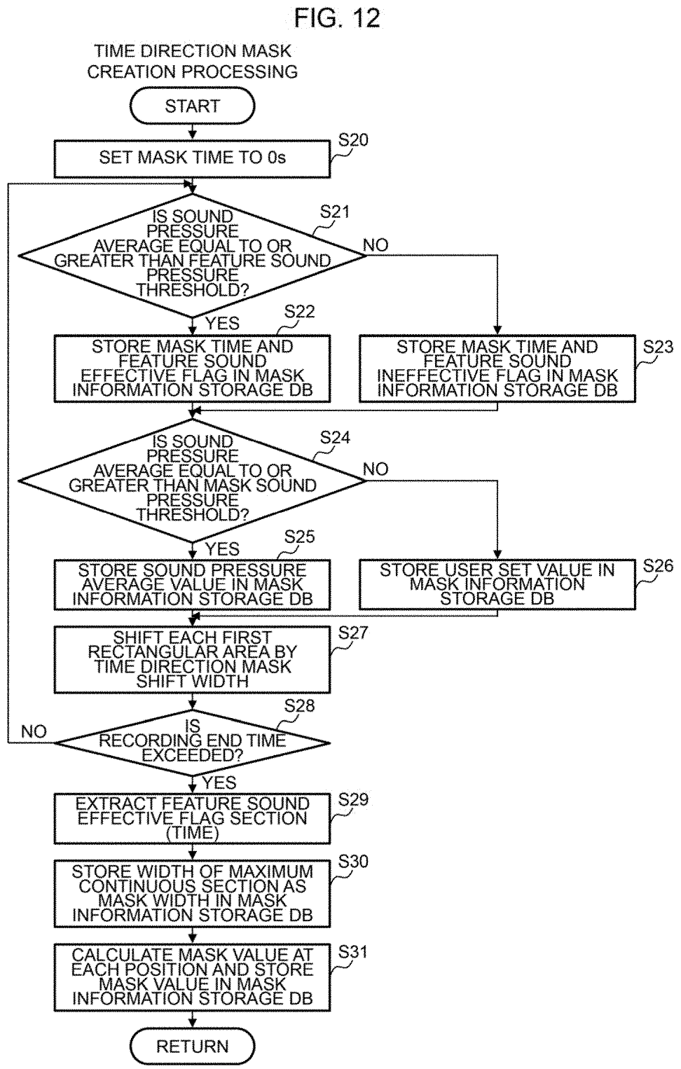

FIG. 12 illustrates specific processing contents of time direction mask creation processing executed by the mask creation section 50 in step S13 of FIG. 11.

Upon proceeding to step S13 in FIG. 11, the mask creation section 50 starts the time direction mask creation processing shown in FIG. 12, and sets a rectangular area (hereinafter referred to as “first mask width rectangular area”) having a height over an entire range in the frequency direction on the spectrogram SG of the inspection target sound data 40 and having a width in the same time direction as the time direction mask shift width (see FIG. 9) set in advance by the user such that the left end time (hereinafter referred to as “mask time” as appropriate) becomes 0 seconds (S20).

Next, the mask creation section 50 judges whether or not an average value of the sound pressure in the current first mask width rectangular area on the spectrogram SG of the inspection target sound data 40 is equal to or larger than the above-mentioned feature sound pressure threshold (see FIG. 9) set by the user (S21).

If this judgment yields an affirmative result, the mask creation section 50 temporarily stores the current mask time and a feature sound effective flag in which a first flag associated with the mask time is set to “on” in the mask information storage database 21 (S22). If a negative result is obtained in step S21, the mask creation section 50 temporarily stores the current mask time and a feature sound ineffective flag in which such a first flag is set to “off” in the mask information storage database 21 (S23).

Next, the mask creation section 50 sets a first mask value rectangular area similar to the above-mentioned first mask width rectangular area at a position where the mask time on the spectrogram SG of the mask creation data 41 is 0 seconds and judges whether or not an average value of a sound pressure in the first mask value rectangular area (hereinafter referred to as “sound pressure average value”) is equal to or larger than the mask sound pressure threshold (see FIG. 9) set in advance by the user (S24).

If this judgment yields an affirmative result, the mask creation section 50 temporarily stores a sound pressure average value in the first mask value rectangular area in association with the position of the first mask value rectangular area at that time in the mask information storage database 21 (S25). In contrast, if a negative result is obtained in step S24, the mask creation section 50 temporarily stores the mask sound pressure threshold (see FIG. 9) in association with the position of the first mask value rectangular area at that time in the mask information storage database 21 (S26).

After this, the mask creation section 50 shifts the first mask width rectangular area set on the spectrogram SG of the inspection target sound data 40 and the first mask value rectangular area set on the spectrogram SG of the mask creation data 41 by the above-mentioned time direction mask shift width (see FIG. 9) set by the user in the direction in which the time in the time direction is delayed (S27).

The mask creation section 50 judges whether or not a mask time after shifting the first mask width rectangular area or the first mask value rectangular area (left-end time of the first mask width rectangular area or the first mask value rectangular area) has exceeded the recording time of the inspection target sound (S28). If this judgment yields a negative result, the mask creation section 50 returns to step S21 and repeats the processes in step S21 to step S28 likewise hereafter until an affirmative result is obtained in step S28.

When the mask time eventually exceeds the recording time of the inspection target sound and an affirmative result is thereby obtained in step S28, the mask creation section 50 extracts all the mask times with which feature sound effective flags are associated, with reference to the mask information storage database 21 (S29).

Next, the mask creation section 50 determines the width of a section (time width) in which most mask times extracted in step S29 are consecutive as the mask width of the time direction mask MK1 and stores the determined mask width as part of the above-mentioned mask data 54 in the mask information storage database 21 (S30).

Furthermore, when the mask creation section 50 shifts the time direction mask MK1 having the mask width determined as described above by the time direction mask shift width in the time direction from a position where the left-end time thereof is 0 seconds until the right-end time becomes a recording time of the inspection target sound, the mask creation section 50 calculates a mask value of the time direction mask MK1 at each mask setting position and stores each calculated mask value as part of the above-mentioned mask data 54 in the mask information storage database 21 (S31).

To be more specific, when the time direction mask MK1 has the same mask width as one first mask value rectangular area, the mask creation section 50 determines a sound pressure average of the first mask value rectangular area at each mask setting position as the mask value of the time direction mask MK1 at the mask setting position and stores the mask value at the determined mask setting position in the mask information storage database 21.

When the time direction mask MK1 has a mask width corresponding to a plurality of first mask value rectangular areas, the mask creation section 50 determines an average value of the sound pressure average value of each first mask value rectangular area included in the mask setting position as the mask value of the time direction mask MK1 at the mask setting position and stores the determined mask value in the mask information storage database 21. After this, the mask creation section 50 ends the time direction mask creation processing and returns to the mask creation processing in FIG. 11.

### (1-2-3-2-3) Frequency Direction Mask Creation Processing

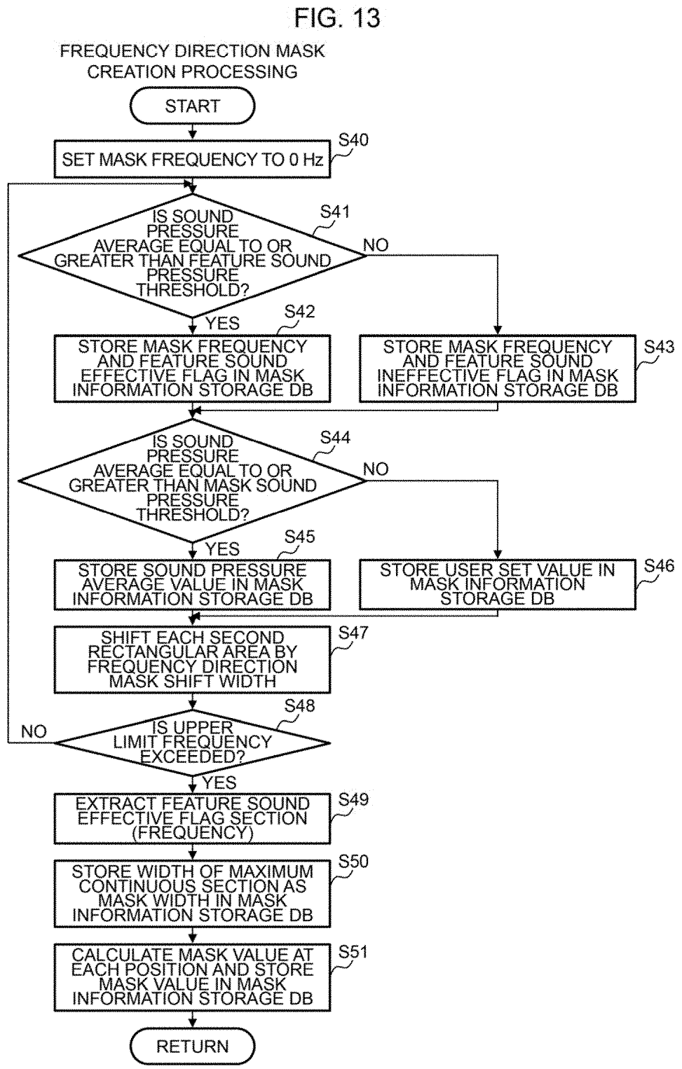

FIG. 13 illustrates specific processing contents of frequency direction mask creation processing executed by the mask creation section 50 in step S15 of FIG. 11.

Upon proceeding to step S15 of FIG. 11, the mask creation section 50 starts the frequency direction mask creation processing shown in FIG. 13 and sets a rectangular area (hereinafter referred to as “second mask width rectangular area”) having a length over an entire range in the time direction on the spectrogram SG of the inspection target sound data 40 and having the same frequency direction width as the frequency direction mask shift width (see FIG. 9) set by the user in advance such that the frequency at a bottom end thereof (hereinafter referred to as “mask frequency”) becomes 0 Hz (S40).

Next, the mask creation section 50 judges whether or not the sound pressure average value in the current second mask width rectangular area on the spectrogram SG of the inspection target sound data 40 is equal to or larger than the feature sound pressure threshold (see FIG. 9) set by the user (S41).

If this judgment yields a positive result, the mask creation section 50 temporarily stores the current mask frequency and a feature sound effective flag in which a second flag associated with the mask frequency is set to “on” in the mask information storage database 21 (S42). When a negative result is obtained in step S41, the mask creation section 50 temporarily stores the current mask frequency and a feature sound ineffective flag in which such a second flag is set to “off” in the mask information storage database 21 (S43).

Next, the mask creation section 50 sets a second mask value rectangular area similar to the above-mentioned second mask width rectangular area at a position on the spectrogram SG of the mask creation data 41 in which a mask frequency is 0 Hz and judges whether or not the sound pressure average value in the second mask value rectangular area is equal to or larger than the user-set mask sound pressure threshold (see FIG. 9) (S44).

If this judgment yields a positive result, the mask creation section 50 temporarily stores a sound pressure average value in the second mask value rectangular area in association with the position of the second mask value rectangular area at that time in the mask information storage database 21 (S45). In contrast, if a negative result is obtained in step S44, the mask creation section 50 temporarily stores the mask sound pressure threshold (see FIG. 9) in association with the position of the second mask value rectangular area in the mask information storage database 21 (S46).

After this, the mask creation section 50 shifts the second mask width rectangular area set on the spectrogram SG of the inspection target sound data 40 and the second mask value rectangular area set on the spectrogram SG of the mask creation data 41 by the above-mentioned user-set frequency direction mask shift width (see FIG. 9) in the frequency direction of higher frequencies (S47).

The mask creation section 50 judges whether or not the mask frequency after shifting the second mask width rectangular area and the second mask value rectangular area (frequency at the bottom end of the second mask width rectangular area or the second mask value rectangular area) has exceeded a maximum frequency on the spectrogram SG (hereinafter referred to as “upper limit frequency”) (S48). If this judgment yields a negative result, the mask creation section 50 returns to step S41 and repeats the processes in step S41 to step S48 likewise hereafter until an affirmative result is obtained in step S48.

When the mask frequency eventually exceeds the upper limit frequency of the spectrogram SG of the inspection target sound data 40 and an affirmative result is thereby obtained in step S48, the mask creation section 50 extracts all the mask frequencies with which the feature sound effective flags are associated, with reference to the mask information storage database 21 (S49).

Next, the mask creation section 50 determines the width of a section (frequency width) with a highest number of consecutive mask frequencies extracted in step S49 as the mask width of the frequency direction mask MK2 and stores the determined mask width as part of the above-mentioned mask data 54 in the mask information storage database 21 (S50).

When the frequency direction mask MK2 having the mask width determined as mentioned above is shifted from a position of the bottom end frequency of 0 Hz until the top end frequency becomes an upper limit frequency by a frequency direction mask shift width at a time, the mask creation section 50 calculates mask values of the frequency direction mask MK2 at the respective mask set values and stores the calculated mask values as part of the above-mentioned mask data 54 in the mask information storage database 21 (S51).

To be more specific, when the frequency direction mask MK2 has the same mask width as the one second mask value rectangular area, the mask creation section 50 determines a sound pressure average value in the second mask value rectangular area at the respective mask setting positions as mask values of the frequency direction mask MK2 at the mask setting positions and stores the mask values at the respective determined mask setting positions in the mask information storage database 21.

When the frequency direction mask MK2 has mask widths corresponding to a plurality of second mask value rectangular areas, the mask creation section 50 determines, for each mask setting position, an average value of sound pressure average values of each second mask value rectangular area included in the mask setting positions as the mask value of the frequency direction mask MK2 at the mask setting position and stores the determined mask value in the mask information storage database 21. After this, the mask creation section 50 ends the frequency direction mask creation processing and returns to the mask creation processing in FIG. 11.

### (1-2-3-2-3) Time Direction×Frequency Direction Mask Creation Processing

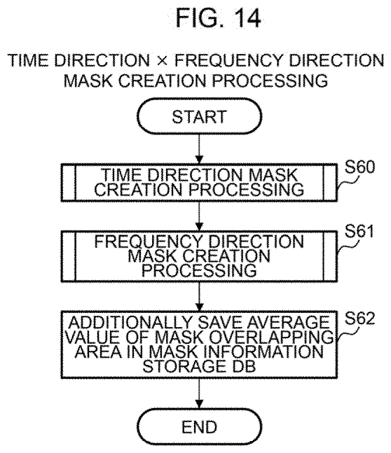

FIG. 14 illustrates specific processing contents of time direction×frequency direction mask creation processing executed by the mask creation section 50 in step S16 of FIG. 11. Upon proceeding to step S16 of FIG. 11, the mask creation section 50 starts the time direction×frequency direction mask creation processing shown in FIG. 14, executes the above-mentioned time direction mask creation processing in FIG. 12 first (S60) and then executes the above-mentioned frequency direction mask creation processing in FIG. 13 (S61).

Next, in each area where the time direction mask MK1 and the frequency direction mask MK2 overlap (hereinafter referred to as “mask overlapping area”), the mask creation section 50 calculates an average value of a mask value of the time direction mask MK1 and a mask value of the frequency direction mask MK2 at that time as a mask value of the mask overlapping area. The mask creation section 50 stores these calculated mask values in association with the position of the time direction mask MK1 and the position of the frequency direction mask MK2 as part of the above-mentioned mask data 54 in the mask information storage database 21 (S62). After this, the mask creation section 50 ends the frequency direction mask creation processing and returns to the mask creation processing.

### (1-2-3-3) Processed Data Creation Processing

### (1-2-3-3-1) Specific Processing Contents of Processed Data Creation Processing

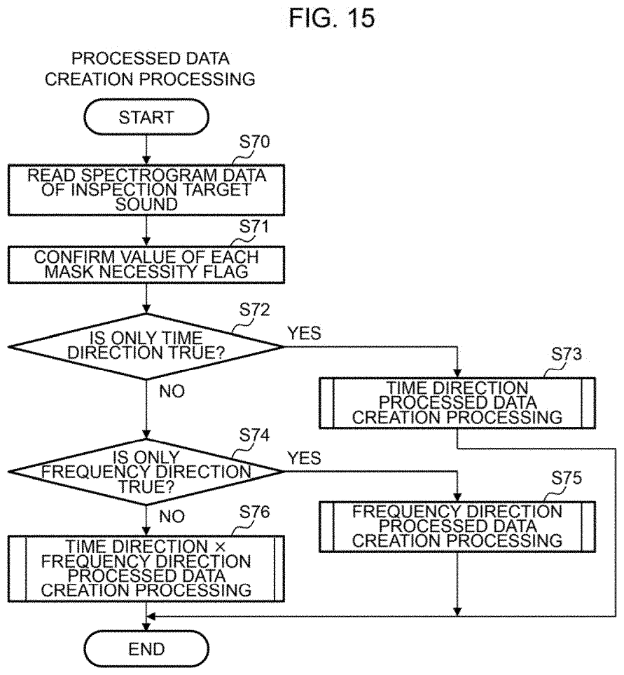

FIG. 15 illustrates a specific flow of a series of processes executed by the processed data creation section 51 in step S6 of the above-mentioned abnormal sound inspection processing in FIG. 10 (hereinafter referred to as “processed data creation processing”). When the abnormal sound inspection processing proceeds to step S6, the processed data creation section 51 starts the processed data creation processing and reads the spectrogram SG data of the inspection target sound data 40 given from the Fourier transform section 30 first (S70).

Next, the processed data creation section 51 confirms values of the time direction mask necessity flag (see FIG. 9) and the frequency direction mask necessity flag (see FIG. 9) (S71) and judges whether or not only the time direction mask necessity flag is “True” (S72).

Obtaining an affirmative result in this judgment means that the processed data 55 should be created using only the time direction mask MK1. Thus, the processed data creation section 51 at this time executes time direction processed data creation processing to sequentially create processed data 55 using only the time direction mask MK1 and sequentially store the obtained processed data 55 in the evidence calculation waveform data storage database 22 (S73). After this, the processed data creation section 51 ends the processed data creation processing.

If a negative result is obtained in step S72, the processed data creation section 51 judges whether or not only the frequency direction mask necessity flag is “True” (S74).

Obtaining an affirmative result in this judgment means that the processed data 55 should be created using only the frequency direction mask MK2. At this time, the processed data creation section 51 executes frequency direction processed data creation processing to sequentially create the processed data 55 using only the frequency direction mask MK2 and sequentially store the processed data 55 in the evidence calculation waveform data storage database 22 (S75). After this, the processed data creation section 51 ends the processed data creation processing.

On the other hand, obtaining a negative result in step S74 means that the processed data 55 should be created using both the time direction mask MK1 and the frequency direction mask MK2. At this time, the processed data creation section 51 executes time direction×frequency direction processed data creation processing to sequentially create the processed data 55 using both the time direction mask MK1 and the frequency direction mask MK2 and sequentially store the acquired processed data 55 in the evidence calculation waveform data storage database 22 (S76). After this, the processed data creation section 51 ends the processed data creation processing.

### (1-2-3-3-2) Time Direction Processed Data Creation Processing

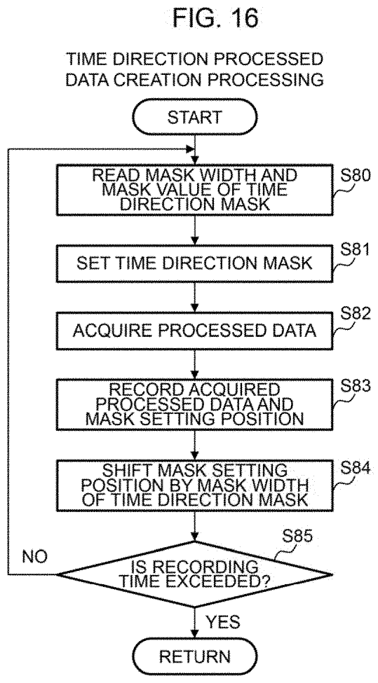

FIG. 16 illustrates specific processing contents of the time direction processed data creation processing executed by the processed data creation section 51 in step S73 of the above-mentioned processed data creation processing in FIG. 15.

Upon proceeding to step S73 in the processed data creation processing, the processed data creation section 51 starts the time direction processed data creation processing shown in FIG. 16, and reads the mask width of the time direction mask MK1 and the mask value corresponding to the current mask setting position from the mask information storage database 21 first (S80). Note that the “current mask setting position” in first step S80 is a mask setting position where the time direction mask MK1 should be set first (position at which the left-end time of the time direction mask MK1 becomes 0 seconds).

Next, the processed data creation section 51 sets the time direction mask MK1 at the current mask setting position and sets the mask value read in step S80 as the mask value of the time direction mask MK1 (S81). Note that the “current mask setting position” in first step S81 is also similar to step S80.

Next, the processed data creation section 51 acquires the spectrogram SG data of the inspection target sound data 40 in which the time direction mask MK1 is set as mentioned above as the processed data 55 (S82). The processed data creation section 51 stores the processed data 55 acquired in step S82 in the evidence calculation waveform data storage database 22 and stores the time at the mask setting position (left-end time of the mask setting position) at this time as the mask position data 56 in the evidence calculation waveform data storage database 22 (S83).

After this, the processed data creation section 51 shifts the mask setting position by the mask width of the time direction mask MK1 in the direction in which the time in the time direction is delayed (S84) and judges whether or not the time of the shifted mask setting position has exceeded the recording time of the inspection target sound (S85).

If this judgment yields a negative result, the processed data creation section 51 returns to step S80, repeats the processes in step S80 to step S85 hereafter until an affirmative result is obtained in step S85. Through this repetitive processing, processed data 55 with the position of the time direction mask MK1 sequentially shifted by the mask width of the time direction mask MK1 in the direction in which the time is delayed is sequentially created, and the created processed data 55 and the position of the time direction mask MK1 (mask setting position) at the time of creation of the processed data 55 are sequentially stored in the evidence calculation waveform data storage database 22.

If an affirmative result is obtained in step S85 by finishing shifting the mask setting position until the time of the mask setting position eventually exceeds the recording time of the inspection target sound, the processed data creation section 51 ends the time direction processed data creation processing and returns to the processed data creation processing.

### (1-2-3-3-3) Frequency Direction Processed Data Creation Processing

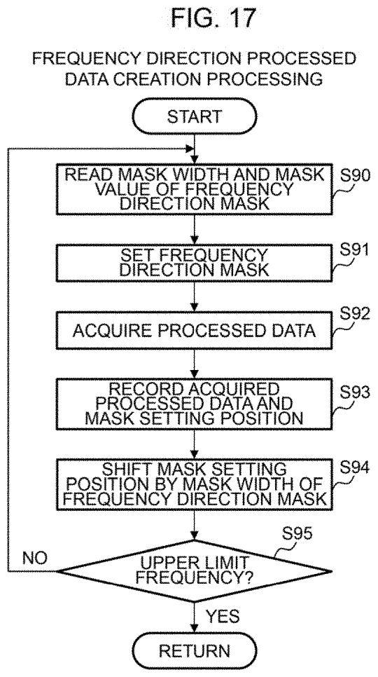

On the other hand, FIG. 17 illustrates specific processing contents of the frequency direction processed data creation processing executed by the processed data creation section 51 in step S75 of the above-mentioned processed data creation processing in FIG. 15.

Upon proceeding to step S75 in the processed data creation processing, the processed data creation section 51 starts frequency direction processed data creation processing shown in FIG. 17 and reads the mask width of the frequency direction mask MK2 and the mask value corresponding to the current mask setting position from the mask information storage database 21 first (S90). Note that the “current mask setting position” in first step S90 is the position where the frequency direction mask MK2 should be set first (position where the bottom end of the frequency direction mask MK2 becomes 0 Hz).

Next, the processed data creation section 51 sets the frequency direction mask MK2 at the current mask setting position and sets the mask value read in step S90 as the mask value of the frequency direction mask MK2 (S91). Note that the “current mask setting position” in first step S91 is also similar to step S90.

Next, the processed data creation section 51 acquires the spectrogram SG data in which the frequency direction mask MK2 is set as mentioned above as the processed data 55 (S92). The processed data creation section 51 stores the processed data 55 acquired in step S92 in the evidence calculation waveform data storage database 22 and stores the frequency at the mask setting position at this time (frequency at the bottom end of the mask setting position) as the mask position data 56 in the evidence calculation waveform data storage database 22 (S93).

After this, the processed data creation section 51 shifts the mask setting position in the frequency direction of higher frequencies by the mask width of the frequency direction mask MK2 (S94) and judges whether or not the frequency at the shifted mask setting position has exceeded an upper limit frequency of the original data (S95).

If this judgment yields a negative result, the processed data creation section 51 returns to step S90 and repeats the processes in step S90 to step S95 until an affirmative result is obtained in step S95. Through the repetitive processing, the processed data 55 with the position of the frequency direction mask MK2 sequentially shifted in the direction of higher frequencies by the mask width of the frequency direction mask MK2 is sequentially created and the created processed data 55 and the position of the frequency direction mask MK2 at the time of creation of the processed data 55 (mask setting position) are sequentially stored in the evidence calculation waveform data storage database 22.

Upon acquiring an affirmative result in step S95 by finishing shifting the mask setting position until the frequency at the mask setting position eventually exceeds the upper limit frequency of the inspection target sound data 40, the processed data creation section 51 ends the frequency direction processed data creation processing and returns to the processed data creation processing.

### (1-2-3-3-4) Time Direction×Frequency Direction Processed Data Creation Processing

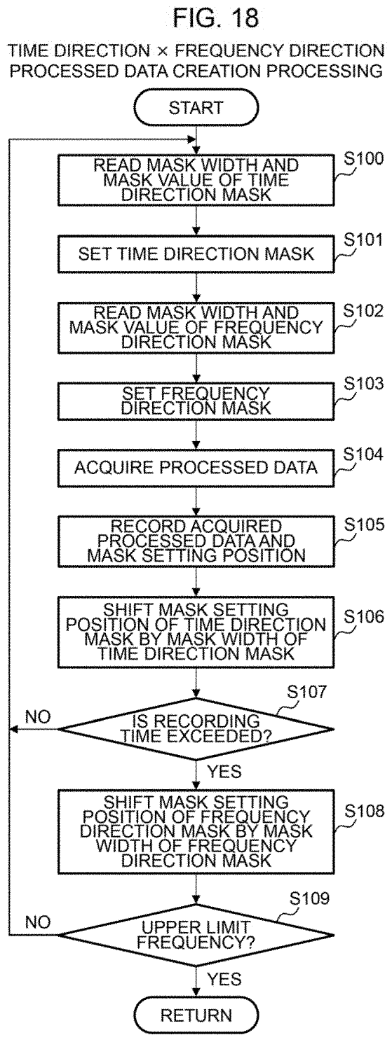

FIG. 18 illustrates specific processing contents of the time direction×frequency direction processed data creation processing executed by the processed data creation section 51 in step S76 of the above-mentioned processed data creation processing in FIG. 15.

Upon proceeding to step S76 of the processed data creation processing, the processed data creation section 51 starts the time direction×frequency direction processed data creation processing shown in FIG. 18 and reads the mask width of the time direction mask MK1 and the mask value corresponding to the current mask setting position from the mask information storage database 21 (S100). Note that the “current mask setting position” in first step S100 is the mask setting position where the time direction mask MK1 should be set first (position where the left-end time of the time direction mask MK1 becomes 0 seconds).

Next, the processed data creation section 51 sets the time direction mask MK1 at the current mask setting position and sets the mask value read in step S100 as the mask value of the time direction mask MK1 (S101). Note that the “current mask setting position” in first step S81 is also similar to step S100.

Next, the processed data creation section 51 reads the mask width of the frequency direction mask MK2 and the mask value corresponding to the current mask setting position from the mask information storage database 21 (S102). Note that the “current mask setting position” in first step S102 is a position where the frequency direction mask MK2 should be set first (position where the bottom end of the frequency direction mask MK2 becomes 0 Hz).

Furthermore, the processed data creation section 51 sets the frequency direction mask MK2 at the current mask setting position and sets the mask value read in step S102 as the mask value of the frequency direction mask MK2 (S103). Note that the “current mask setting position” in first step S103 is also similar to step S102.

After this, the processed data creation section 51 acquires the spectrogram SG data of the inspection target sound data 40 in which the time direction mask MK1 and the frequency direction mask MK2 are set as mentioned above as the processed data 55 (S104). The processed data creation section 51 stores the processed data 55 acquired in step S104 in the evidence calculation waveform data storage database 22 and stores the time of the mask setting position at which the time direction mask MK1 is set at this time (left-end time of the mask setting position) and the frequency at the mask setting position at which the frequency direction mask MK2 is set at this time (time on the lower side of the mask setting position) as the mask position data 56 in the evidence calculation waveform data storage database 22 (S105).

After this, the processed data creation section 51 shifts the mask setting position of the time direction mask MK1 by the mask width of the time direction mask MK1 in the direction in which the time in the time direction is delayed (S106) and judges whether or not the time of the shifted mask setting position has exceeded the recording time of the inspection target sound (S107).

If this judgment yields a negative result, the processed data creation section 51 returns to step S100 and repeats the processes in step S100 to step S107 until an affirmative result is obtained in step S107 hereafter. Through the repetitive processing, while the frequency direction mask MK2 is fixed at one location, the processed data 55 with the position of the time direction mask MK1 sequentially shifted by the mask width of the time direction mask MK1 in the direction in which the time is delayed is sequentially created and the created processed data 55 and the position of the time direction mask MK1 and the position of the frequency direction mask MK2 at the time of creation of the processed data 55 (mask setting positions) are sequentially stored in the evidence calculation waveform data storage database 22.

Upon obtaining an affirmative result in step S107 by finishing shifting the mask setting position until the time at the mask setting position of the time direction mask MK1 eventually exceeds the recording time of the inspection target sound, the processed data creation section 51 shifts the mask setting position of the frequency direction mask MK2 in the frequency direction of higher frequencies by the mask width of the frequency direction mask MK2 (S108) and judges whether or not the frequency at the mask setting position of the shifted frequency direction mask MK2 has exceeded an upper limit frequency (S109).

If this judgment yields a negative result, the processed data creation section 51 returns to step S100 and repeats the processes in step S100 to step S109 until an affirmative result is obtained in step S109. Through this repetitive processing, processed data 55 is created in all combinations when the time direction mask MK1 is set at any mask setting position and the frequency direction mask MK2 is set at any mask setting position, and the created processed data 55 and the position of the time direction mask MK1 at the time of creation of the processed data 55 and the position of the frequency direction mask MK2 (mask setting positions) are sequentially stored in the evidence calculation waveform data storage database 22.

If an affirmative result is obtained in step S109 by finishing shifting the mask setting position until the frequency at the mask setting position of the frequency direction mask MK2 eventually exceeds the upper limit frequency of the inspection target sound data 40, the processed data creation section 51 ends this time direction×frequency direction processed data creation processing and returns to the processed data creation processing.

### (1-2-3-4) Anomaly Score/Change Rate Calculation Processing

### (1-2-3-4-1) First Anomaly Score/Change Rate Calculation Processing

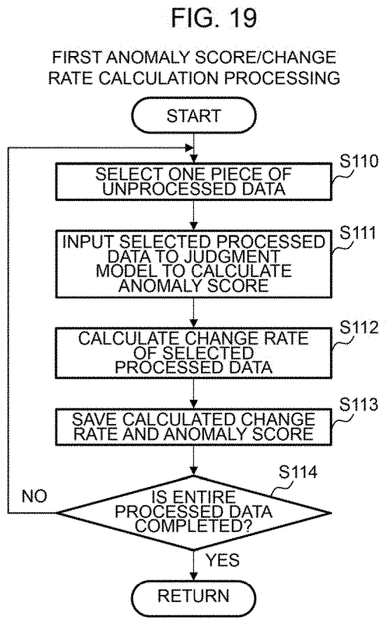

When the judgment model 20A of the judgment model section 20 is a machine learning model other than the auto encoder scheme, FIG. 19 illustrates a specific flow of a series of processes (hereinafter referred to as “first anomaly score/change rate calculation processing”) executed by the anomaly score/change rate calculation section 52 in step S7 of the above-mentioned abnormal sound inspection processing in FIG. 10.

When the abnormal sound inspection processing proceeds to step S7, the anomaly score/change rate calculation section 52 starts this first anomaly score/change rate calculation processing. The anomaly score/change rate calculation section 52 selects one piece of processed data 55 unprocessed in and after step S111 from the processed data 55 stored in the evidence calculation waveform data storage database 22 first (S110), outputs the selected processed data (hereinafter referred to as “selected processed data” in the description of FIG. 19) 55 to the judgment model section 20 of the inspection judgment section 31 and causes the judgment model 20A to calculate anomaly score of the processed data 55 (S111).

Next, the anomaly score/change rate calculation section 52 calculates a change rate of the selected processed data 55 from the original data 46 (spectrogram SG data of the inspection target sound data 40) based on the anomaly score of the selected processed data 55 calculated by the judgment model 20A given from the judgment model section 20 as a result in step S111 (S112).

To be more specific, the anomaly score/change rate calculation section 52 reads the original data anomaly score 45 stored in the judgment evidence information storage database 23 and calculates the change rate of the selected processed data 55 from the anomaly score of the original data 46 using the read original data anomaly score 45 and the anomaly score of the selected processed data 55 calculated by the judgment model 20A of the judgment model section 20 using above-mentioned Equation (2).

Next, the anomaly score/change rate calculation section 52 stores the anomaly score of the selected processed data 55 calculated from the judgment model 20A of the judgment model section 20 and the change rate from the original data 46 calculated in step S112 as the processed data anomaly score/change rate information 57 in the judgment evidence information storage database 23 (S113), and then judges whether or not the processes in and after step S111 on all the processed data 55 stored in the evidence calculation waveform data storage database 22 have been executed (S114).

If this judgment yields a negative result, the anomaly score/change rate calculation section 52 returns to step S110, and then repeats the processes in step S110 to step S114 while sequentially switching the processed data 55 to be selected in step S110 to other processed data 55 unprocessed in and after step S111. Through this repetitive processing, change rates of all the processed data 55 from the anomaly score and/original data 46 stored in the evidence calculation waveform data storage database 22 as shown in FIG. 19 are calculated and stored as the processed data anomaly score/change rate information 57 in the judgment evidence information storage database 23.

Upon obtaining an affirmative result in step S114 by finishing storing the processed data anomaly score/change rate information 57 of all the processed data 55 eventually stored in the evidence calculation waveform data storage database 22 in the judgment evidence information storage database 23, the anomaly score/change rate calculation section 52 ends the first anomaly score/change rate calculation processing and returns to the abnormal sound inspection processing in FIG. 10.

### (1-2-3-4-2) Second Anomaly Score/Change Rate Calculation Processing

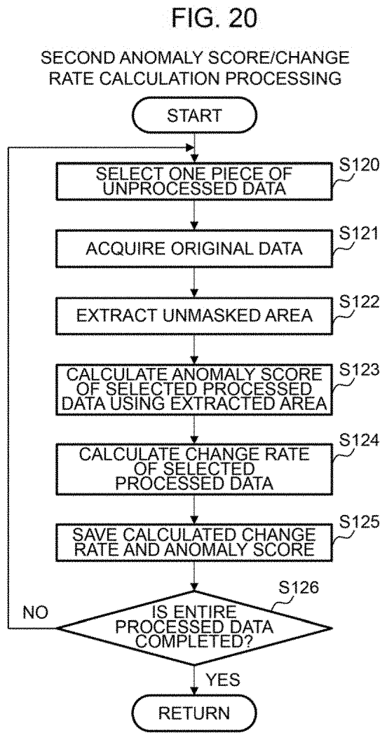

On the other hand, when the judgment model 20A of the judgment model section 20 is an auto encoder method machine learning model, FIG. 20 illustrates a specific flow of a series of processes (hereinafter referred to as “second anomaly score/change rate calculation processing”) executed by the anomaly score/change rate calculation section 52 in step S7 of the above-mentioned abnormal sound inspection processing in FIG. 10. When the abnormal sound inspection processing proceeds to step S7, the anomaly score/change rate calculation section 52 starts the second anomaly score/change rate calculation processing shown in FIG. 20.

The anomaly score/change rate calculation section 52 selects one piece of the processed data 55 unprocessed in and after step S121 from the processed data 55 stored in the evidence calculation waveform data storage database 22 (S120). Hereinafter, this will be referred to as selected processed data 55 in the description in FIG. 19. The anomaly score/change rate calculation section 52 reads and acquires the original data 46 which is spectrogram SG data of the inspection target sound data 40 from the judgment evidence information storage database 23 (S121).

Next, of the masked spectrogram SG of the inspection target sound data 40, the anomaly score/change rate calculation section 52 extracts areas not masked by the time direction mask MK1 and the frequency direction mask MK2 (unprocessed area) (S122). More specifically, the anomaly score/change rate calculation section 52 extracts the non-masked areas of the selected processed data 55 by reading the mask position data 56 from the evidence calculation waveform data storage database 22 and the mask data (mask width) from the mask information storage database 21. The anomaly score/change rate calculation section 52 calculates anomaly score of the non-processed area extracted in step S122 as anomaly score of the selected processed data 55 based on the original data 46 acquired in step S121 (S123). To be more specific, the anomaly score/change rate calculation section 52 calculates an average value of anomaly scores of the respective pixels included in the non-processed area as anomaly score of the selected processed data.

Next, the anomaly score/change rate calculation section 52 calculates a change rate of the selected processed data 55 from the original data 46 based on the anomaly score calculated in step S123 (S124). To be more specific, the anomaly score/change rate calculation section 52 reads the original data anomaly score 45 stored in the judgment evidence information storage database 23 and calculates a change rate of the selected processed data 55 with respect to the original data 46 by above-mentioned Equation (2) using the read original data anomaly score 45 and the anomaly score of the selected processed data 55 calculated in step S123.

Next, the anomaly score/change rate calculation section 52 stores the anomaly score of the selected processed data 55 calculated in step S123 and the change rate of the selected processed data 55 from the original data 46 calculated in step S124 as the processed data anomaly score/change rate information 57 in the judgment evidence information storage database 23 (S125).

After this, the anomaly score/change rate calculation section 52 judges whether or not the processes in and after step S121 have been executed on all the processed data 55 stored in the evidence calculation waveform data storage database 22 (S126).

If this judgment yields a negative result, the anomaly score/change rate calculation section 52 returns to step S120, and repeats hereafter, the processes in step S120 to step S126 while sequentially switching the processed data 55 to be selected in step S120 to the other processed data 55 unprocessed in and after step S121. Through this repetitive processing, anomaly scores and change rates of all the processed data 55 stored in the evidence calculation waveform data storage database 22 are calculated and stored as the processed data anomaly score/change rate information 57 in the judgment evidence information storage database 23.

Upon acquiring an affirmative result in step S126 by finishing storing the processed data anomaly score/change rate information 57 of all the processed data 55 eventually stored in the evidence calculation waveform data storage database 22 in the judgment evidence information storage database 23, the anomaly score/change rate calculation section 52 ends this second anomaly score/change rate calculation processing and returns to the abnormal sound inspection processing in FIG. 10.

### (1-2-3-5) Judgment Evidence Drawing

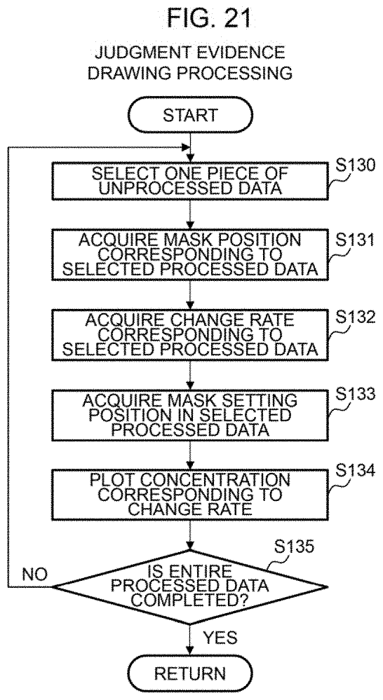

FIG. 21 illustrates a specific flow of a series of processes executed by the judgment evidence drawing section 53 in step S8 of the above-mentioned abnormal sound inspection processing in FIG. 10 (hereinafter referred to as “judgment evidence drawing”).

When the abnormal sound inspection processing proceeds to step S8, the judgment evidence drawing section 53 starts judgment evidence drawing shown in FIG. 21, and first selects one piece of the processed data 55 unprocessed in and after step S131 from the processed data 55 stored in the evidence calculation waveform data storage database 22 (S130).

Next, the judgment evidence drawing section 53 reads and acquires the mask position data 56 of the processed data selected in step S130 (hereinafter referred to as “selected processed data” in the description in FIG. 20) from the evidence calculation waveform data storage database 22 (S131), and reads and acquires the change rate corresponding to the selected processed data 55 (here, processed data anomaly score/change rate information 57) from the judgment evidence information storage database 23 (S132).

Next, the judgment evidence drawing section 53 extracts and acquires the mask setting position of the selected processed data 55 from the mask position data 56 acquired in step S131 (S133).

Furthermore, the judgment evidence drawing section 53 plots (colors) the mask setting positions where the masks of the spectrogram SG corresponding to the selected processed data 55 in the spectrogram SG of the inspection target sound data 40 (time direction mask MK1 and frequency direction mask MK2) are set, with a color or concentration corresponding to the change rate acquired in step S132 based on the calculation result in step S133 (S134).

The judgment evidence drawing section 53 then judges whether or not the processes in step S131 to step S134 on all the processed data 55 stored in the evidence calculation waveform data storage database 22 have been executed (S135).

If this judgment yields a negative result, the judgment evidence drawing section 53 returns to step S130, and repeats hereafter, the processes in step S130 to step S135 until an affirmative result is obtained in step S135 while sequentially switching the processed data 55 to be selected in step S130 to the other processed data 55 unprocessed in and after step S131. Through this repetitive processing, the above-mentioned judgment evidence image 24 in FIG. 5 is gradually drawn.

Upon obtaining an affirmative result in step S135 by finishing executing the processes in step S131 to step S134 on all the processed data 55 eventually stored in the evidence calculation waveform data storage database 22, the judgment evidence drawing section 53 ends this judgment evidence drawing and returns to the above-mentioned abnormal sound inspection processing in FIG. 10.

### (1-3) Effects of Present Embodiment

As described above, the abnormal sound inspection apparatus 1 of the present embodiment generates a judgment evidence image 24 obtained by plotting (coloring) each mask setting position at which the time direction mask MK1 or the frequency direction mask MK2 on the spectrogram SG of inspection target sound data is set, with a color or concentration corresponding to a change rate of the processed data 55 in which the time direction mask MK1 or the frequency direction mask MK2 is set at each mask setting position from the original data 46 and displays the generated judgment evidence image 24 together with the judgment result of the inspection judgment section 31.

Therefore, according to the present abnormal sound inspection apparatus 1, it is possible to reliably show evidence of a judgment result of a judgment on the presence or absence of abnormality using the judgment model 20A of the judgment model section 20 acquired by machine learning and thus implement a high value-added abnormal sound inspection apparatus.

### (2) Second Embodiment

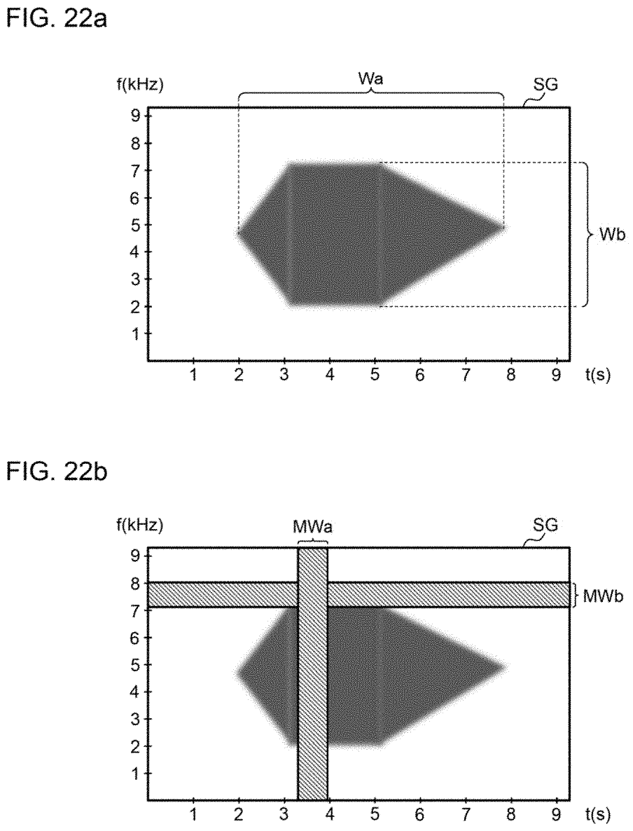

In the first embodiment, when the spectrogram SG of the inspection target sound data 40 has a feature over a wide range in both the frequency direction and the time direction for example, as shown in FIG. 22A (both the feature frequency width Wa and the feature time width Wb in FIG. 22A are large), according to the above-mentioned mask creation processing in FIG. 11 to FIG. 14, both the mask width of the time direction mask MK1 and the mask width of the frequency direction mask MK2 become excessively large, and it is thereby not possible to draw the judgment evidence image 24 with high resolution.

Thus, according to the present embodiment, when a feature of the inspection target sound using both the time direction mask MK1 and the frequency direction mask MK2 is extracted, fixed values set in advance are used as a mask width MWa of the time direction mask MK1 and a mask width MWb of the frequency direction mask MK2 as shown in FIG. 22B. Hereinafter, the abnormal sound inspection apparatus according to the second embodiment having such functions will be described.

In FIG. 1 and FIG. 8, reference numeral 60 denotes an abnormal sound inspection apparatus according to the second embodiment. The abnormal sound inspection apparatus 60 is configured to be similar to the abnormal sound inspection apparatus 1 according to the first embodiment except that the function of a mask creation section 62 (FIG. 8) embodied when the CPU 2 (FIG. 1) executes a mask creation program 61 (FIG. 1) stored in the memory 3 (FIG. 1) is different from the mask creation section 50 of the first embodiment.

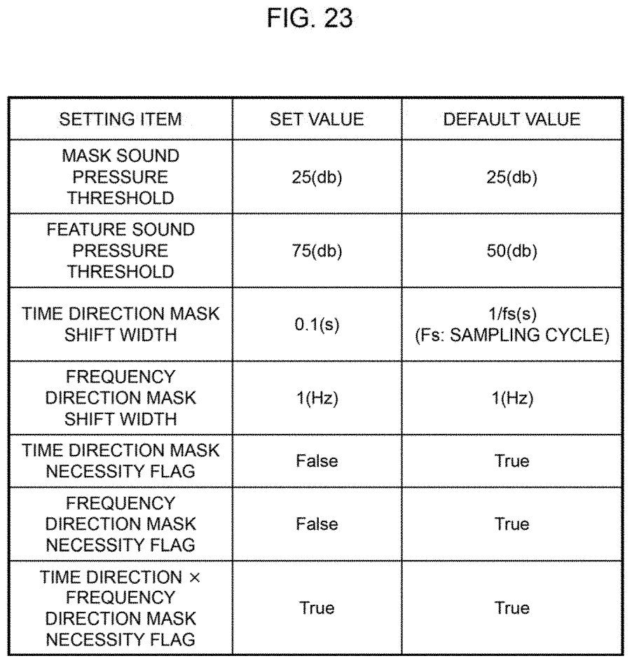

Actually, as shown in FIG. 23, the abnormal sound inspection apparatus 60 of the present embodiment manages a time direction mask necessity flag, a frequency direction mask necessity flag, and a time direction×frequency direction mask necessity flag using both the time direction mask and the frequency direction mask in addition to the respective default values and user set values of the above-mentioned mask sound pressure threshold, the feature sound pressure threshold, the time direction mask shift width and the frequency direction mask shift width.

When the user makes a setting that the time direction mask MK1 should be used, the value of the time direction mask necessity flag is set to “True” whereas when the user makes a setting that the frequency direction mask MK2 should be used, the value of the frequency direction mask necessity flag is set to “True.” Furthermore, when the user makes a setting that both the above-mentioned time direction mask MK1 and frequency direction mask MK2, the mask width of which is fixed by the user, should be used, the time direction×frequency direction mask necessity flag is set to “True.”

During live operation, when any one of the time direction mask necessity flag and the frequency direction mask necessity flag is set to “True,” the mask creation section 62 calculates each mask width of the time direction mask MK1 or the frequency direction mask MK2 to be created at that time, a mask value at each mask setting position of the time direction mask MK1 or the frequency direction mask MK2 based on the spectrogram SG data of the inspection target sound data 40 and the spectrogram SG data of the mask creation data 41 given from the Fourier transform section 30 and the above-mentioned various settings in FIG. 23 by the user as the case with the first embodiment. The mask creation section 50 stores these calculated mask widths and the mask values at the respective mask setting positions as the mask data 54 in the mask information storage database 21.

In contrast, during live operation, if the time direction×frequency direction mask necessity flag is set to “True,” the mask creation section 62 calculates mask values for the respective positions at which the time direction mask MK1 and frequency direction mask MK2 should be set based on the spectrogram data of the inspection target sound data 40 and the spectrogram SG data of the mask creation data 41 given from the Fourier transform section 30 and the above-mentioned various settings in FIG. 23 by the user. The mask creation section 50 stores the calculated mask values of the time direction mask MK1 and frequency direction mask MK2 for the respective positions in which the time direction mask MK1 and the frequency direction mask MK2 should be set and the mask width of the time direction mask MK1 and the mask width of the frequency direction mask MK2 set in advance as the mask data 54 in the mask information storage database 21.

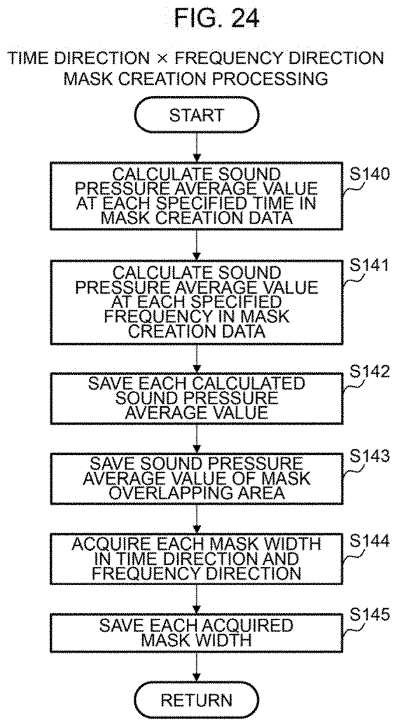

FIG. 24 illustrates processing contents of time direction×frequency direction mask creation processing according to the second embodiment executed by the mask creation section 62 of the present embodiment in step S16 of the above-mentioned mask creation processing in FIG. 11, instead of the time direction×frequency direction mask creation processing of the above-mentioned first embodiment in FIG. 14.

Upon proceeding to step S16 in FIG. 11, the mask creation section 62 starts time direction×frequency direction mask creation processing shown in FIG. 24, and calculates a sound pressure average value at each specified time on the spectrogram SG of the mask creation data 41 first (S140). The “specified time” here means the time in the center in the time direction at each mask setting position at which the time direction mask MK1 is set on the spectrogram SG of the inspection target sound data 40.

In the present embodiment, when both the time direction mask MK1 and the frequency direction mask MK2 are used as mentioned above, since the mask widths of the time direction mask MK1 and the frequency direction mask MK2 are fixed, each mask setting position at which the time direction mask MK1 on the spectrogram SG of the inspection target sound data 40 is set is also fixedly determined according to the time direction mask shift width. Thus, in the case of the present embodiment, the mask creation section 62 calculates mask values at these mask setting positions as an average value of sound pressure in the frequency direction at the central time in the time direction at the mask setting positions on the spectrogram SG of the mask creation data 41.

Next, the mask creation section 62 calculates a sound pressure average values at each specified frequency on the spectrogram SG of the mask creation data 41 (S141). The “specified frequency” here means a frequency in the center in the frequency direction at each mask setting position where the frequency direction mask MK2 is set on the spectrogram SG of the inspection target sound data 40.

As mentioned above, when both the time direction mask MK1 and the frequency direction mask MK2 are used, since mask widths of the time direction mask MK1 and the frequency direction mask MK2 are fixed, each mask setting position in which the frequency direction mask MK2 on the spectrogram SG of the inspection target sound data 40 is fixedly determined according to the frequency direction mask shift width. Thus, in the case of the present embodiment, the mask creation section 62 calculates the mask values at these mask setting positions as an average value of the sound pressure in the time direction at the center frequency in the frequency direction at the mask setting positions on the spectrogram SG of the mask creation data 41.

Next, the mask creation section 62 stores each mask setting position of the time direction mask MK1 and the sound pressure average value calculated in step S140 at these mask setting positions (mask values at these mask setting positions) as the mask data 54 in the mask information storage database 21. Together with this, the mask creation section 62 stores each mask setting position of the frequency direction mask MK2 and the sound pressure average value calculated in step S141 at these mask setting positions (mask values at these mask setting positions) as part of the mask data 54 in the mask information storage database 21 (S142).

Furthermore, the mask creation section 62 calculates an average value of each sound pressure average value of the time direction mask MK1 and the frequency direction mask MK2 in the overlapping area of the time direction mask MK1 and the frequency direction mask MK2 and stores the calculated average value, in other words, the sound pressure average value in the overlapping area (that is, mask values of the time direction mask MK1 and the frequency direction mask MK2 in the overlapping area) as part of the mask data 54 in the mask information storage database 21 (S143).

Next, the mask creation section 62 acquires the mask width of the time direction mask MK1 and the mask width of the frequency direction mask MK2 set in advance (S144) and stores these acquired mask widths as part of the mask data 54 in the mask information storage database 21 (S145). The mask creation section 62 then ends the time direction×frequency direction mask creation processing.

According to the abnormal sound inspection apparatus 60 of the present embodiment having the above mentioned configuration, even when the spectrogram SG of the inspection target sound data 40 has features over a wide range in both the frequency and time directions, it is possible to draw a high resolution judgment evidence image 24 and thereby obtain an effect of being able to provide more accurate information in addition to the effects achieved in the first embodiment.

### (3) Other Embodiments

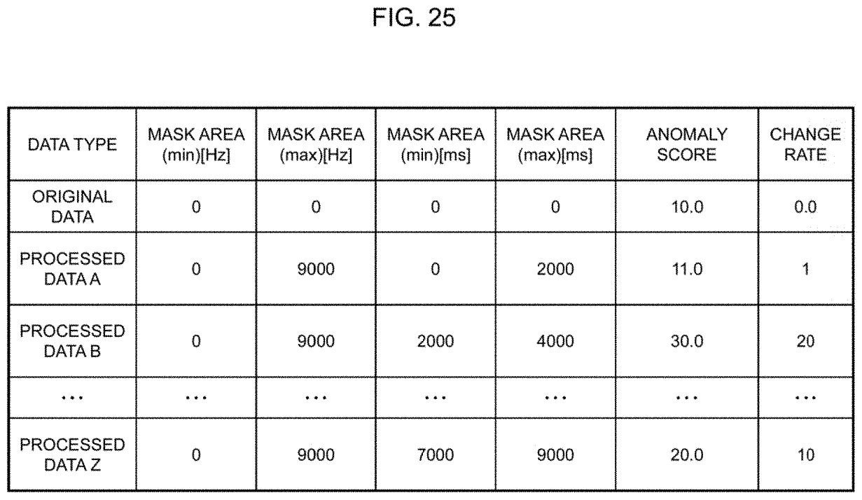

Note that although a case has been described in the above-mentioned first and second embodiments where the judgment evidence image 24 mentioned above in FIG. 5 is generated and displayed using the change rate for each piece of the processed data 55 calculated using Equation (2), the present invention is not limited to this, but it may also be possible to calculate the change degree of each piece of the processed data 55 as shown in FIG. 25 based on the change degree calculated, for example, by the following equation:

[Expression 3]

CHANGE DEGREE=ANOMALY SCORE OF PROCESSED DATA−ANOMALY SCORE OF ORIGINAL DATA (3)

and generate and display the judgment evidence image 24 in the same way as the change rate based on the change degree for each piece of the calculated processed data 55. In this case, since processing contents of various processes executed by the abnormal sound inspection apparatus 1 are similar to those of the above-mentioned first and second embodiments by only reading the “change rate” as the “change degree,” description here will be omitted. Even if this is the case, effects similar to those of the first and second embodiments can be obtained.

Note that if the change degree is used, in the case of FIG. 6A and FIG. 22A where feature sound is contained in both the frequency direction and the time direction in the inspection target sound, in the above-mentioned mask creation processing in FIG. 11, the change degree of the time direction mask MK1 calculated along the route in step S12-step S13 and the change degree of the frequency direction mask MK2 calculated along the route in step S12-step S14-step S15 added together may be defined as a new change degree and the judgment evidence image 24 may be drawn using this change degree.

Although a case has been described in the above-mentioned first and second embodiment where the target for judging the presence or absence of abnormality is sound data, the present invention is not limited to this, but the present invention is widely applicable to judge the presence or absence of abnormality in various waveform data such as voltage data or current data other than sound data.

Furthermore, although a case has been described in the above-mentioned first and second embodiments, where the mask setting positions at which the spectrogram SG masks (time direction mask MK1 and frequency direction mask MK2) corresponding to the processed data 55 on the spectrogram SG of the inspection target sound data 40 are set are plotted (colored) with a color or concentration corresponding to the change rate from the original data 46 of the processed data 55, the present invention is not limited to this, but the change rate related to each mask set value may be displayed as a numerical value. However, as in the cases of the first and second embodiments, by plotting (coloring) such mask setting positions with a color or concentration corresponding to the change rate of the processed data 55 from the original data 46, it is possible to generate the judgment evidence image 24 with high viewability.

Furthermore, although a case has been described in the above-mentioned first and second embodiments, where the mask values of the time direction mask MK1 and the frequency direction mask MK2 at the respective mask setting positions are calculated based on an average value of environment sound at the mask setting positions, the present invention is not limited to this, but it may also be possible to calculate mask values using, for example, sound data (teacher data) used to create (learn) the judgment model 20A of the judgment model section 20 instead of environment sound as in the case of the above-mentioned environment sound. In the case where environment sound is used, it may also be possible to apply not an average value at the mask setting position but a direct value (overwrite the value of each mask setting position to the mask setting position of the inspection target sound as is from the spectrogram of the environment sound) or further combine these two methods to overwrite the value of each mask setting position to the mask setting position of the inspection target sound as is from the spectrogram of the sound data (teacher data) used to create (learn) the judgment model 20A.

### INDUSTRIAL APPLICABILITY

The present invention is widely applicable to various inspection apparatuses to performing abnormality judgment of inspection, waveform data.

### REFERENCE SIGNS LIST

1, 60 . . . abnormal sound inspection apparatus, 2 . . . CPU, 6 . . . display apparatus, 10 . . . Fourier transform program, 11 . . . normality/abnormality judgment program, 12 . . . abnormality detection result output program, 13, 61 . . . mask creation program, 14 . . . processed data creation program, 15 . . . anomaly score/change rate calculation program, 16 . . . judgment evidence drawing program, 17 . . . result display program, 20 . . . judgment model, 21 . . . mask information storage database, 22 . . . judgment evidence calculation waveform data storage database, 23 . . . judgment evidence information storage database, 24 . . . judgment evidence image, 30 . . . Fourier transform section, 31 . . . inspection judgment section, 32 . . . judgment evidence calculation section, 33 . . . result display section, 40 . . . inspection target sound data, 41 . . . mask creation data, 44 . . . judgment result information, 45 . . . original data anomaly score, 46 . . . original data, 50, 62 . . . mask creation section, 51 . . . processed data creation section, 52 . . . anomaly score/change rate calculation section, 53 . . . judgment evidence drawing section, 54 . . . mask data, 55 . . . processed data, 56 . . . mask position data, 57 . . . processed data anomaly score/change rate information, 58 . . . judgment evidence information, MK1 . . . time direction mask, MK2 . . . frequency direction mask, SG . . . spectrogram.

What is claimed is:

1. An inspection apparatus that judges the presence or absence of abnormality based on a spectrogram of waveform data, comprising:
an inspection judgment section that calculates anomaly score of the spectrogram of the waveform data using a judgment model obtained by machine learning and judges the presence or absence of abnormality based on the calculated anomaly score;
a processed data creation section that creates a plurality of pieces of processed data with a mask corresponding to characteristics of the waveform data set on the spectrogram of the waveform data so as to sequentially shift the mask in a direction corresponding to the mask;
an anomaly score/change degree calculation section that calculates anomaly score of the processed data created by the processed data creation section and calculates each change rate or change degree of the waveform data of the processed data from the spectrogram based on the anomaly score of the calculated processed data and the anomaly score of the spectrogram of the waveform data calculated by the inspection judgment section;
a judgment evidence drawing section that draws a judgment evidence image obtained by coloring each area in which the mask on the spectrogram of the waveform data is set based on the change rate or change degree of the calculated processed data from the spectrogram of the waveform data, with a color or concentration corresponding to the change rate or change degree of the processed data when the mask is set; and
a result display section that displays the judgment result of the inspection judgment section and the judgment evidence image drawn by the judgment evidence drawing section.

2. The inspection apparatus according to claim 1, wherein the processed data creation section creates the processed data using at least one of an elongated rectangular first mask over an entire range in a frequency direction parallel to the frequency direction of the spectrogram and an elongated rectangular second mask over an entire range in a time direction parallel to the time direction of the spectrogram as the mask.

3. The inspection apparatus according to claim 2, further comprising a mask creation section that calculates a width in the time direction of an area on the spectrogram of the waveform data where features of the waveform data appear as a mask width of the first mask and calculates a width in the frequency direction of the area on the spectrogram of the waveform data where the features of the waveform data appear as a mask width of the second mask, wherein
the processed data creation section creates the processed data using the mask with the mask width calculated from the mask creation section.

4. The inspection apparatus according to claim 3, wherein
the mask creation section determines a mask value of the mask at each position where the mask on the spectrogram is set based on an average value of the data value of each area part in which the mask on the spectrogram of the waveform data should be set, and
the processed data creation section creates the processed data using the mask with the mask value determined by the mask creation section.

5. The inspection apparatus according to claim 4, wherein
when an average value of data value of each area part in which the mask on the spectrogram of the waveform data provided in advance is set is equal to or larger than a predetermined threshold, the mask creation section determines the average value as the mask value of the mask, and when the average value is smaller than the threshold, the mask creation section determines a predetermined value as the mask value of the mask.

6. The inspection apparatus according to claim 1, wherein
when the judgment model is an auto encoder machine learning model, the anomaly score/change degree calculation section calculates an average value of abnormality value of each pixel in unprocessed areas other than the area of the spectrogram of the waveform data in which the mask is set as an abnormality value of the spectrogram of the waveform data when the mask is set in the area.

7. The inspection apparatus according to claim 2, wherein
the processed data creation section creates the processed data using the first and second masks with the fixed mask width.

8. An inspection method executed by an inspection apparatus that judges the presence or absence of abnormality based on a spectrogram of waveform data, the method comprising:
a first step of calculating anomaly score of the spectrogram of the waveform data using a judgment model obtained by machine learning and judging the presence or absence of abnormality based on the calculated anomaly score;
a second step of creating a plurality of pieces of processed data with a mask corresponding to characteristics of the waveform data set on the spectrogram of the waveform data so as to sequentially shift the mask in a direction corresponding to the mask;
a third step of calculating anomaly score of the created processed data and calculating each change rate or change degree of the waveform data of the processed data from the spectrogram based on the calculated anomaly score of processed data and the calculated anomaly score of the spectrogram of the waveform data;
a fourth step of drawing a judgment evidence image obtained by coloring each area in which the mask on the spectrogram of the waveform data is set based on the change rate or change degree of the calculated processed data from the spectrogram of the waveform data, with a color or concentration corresponding to the change rate or change degree of the processed data when the mask is set; and
a fifth step of displaying the judgment result about the presence or absence of the abnormality and the drawn judgment evidence image.

9. The inspection method according to claim 8, wherein in the second step, the inspection apparatus creates the processed data using at least one of an elongated rectangular first mask over an entire range in a frequency direction parallel to the frequency direction of the spectrogram and an elongated rectangular second mask over an entire range in a time direction parallel to the time direction of the spectrogram as the mask.

10. The inspection method according to claim 9, wherein
in the second step, the inspection apparatus calculates a width in the time direction of an area on the spectrogram of the waveform data where features of the waveform data appear as the mask width of the first mask and calculates a width in the frequency direction of the area on the spectrogram of the waveform data where the features of the waveform data appear as the mask width of the second mask, and
the processed data is created using the mask with the calculated mask width.

11. The inspection method according to claim 10, wherein
in the second step, the inspection apparatus determines the mask value of the mask at each position where the mask on the spectrogram is set based on an average value of the data value of each area part for which the mask on the spectrogram of the waveform data should be set, and
the processed data is created using the mask with the determined mask value.

12. The inspection method according to claim 11, wherein in the second step, when an average value of data value of each area part in which the mask on the spectrogram of the waveform data provided in advance is equal to or larger than a predetermined threshold, the inspection apparatus determines the average value as the mask value of the mask, and when the average value is smaller than the threshold, the inspection apparatus determines a predetermined value as the mask value of the mask.

13. The inspection method according to claim 8, wherein in the third step, when the judgment model is an auto encoder machine learning model, the inspection apparatus calculates an average value of abnormality value at each pixel in unprocessed areas other than the area of the spectrogram of the waveform data in which the mask is set as an abnormality value of the spectrogram of the waveform data when the mask is set in the area.

14. The inspection method according to claim 9, wherein in the second step, the inspection apparatus creates the processed data using the first and second masks with the fixed mask width.
